(19) United States
(12) Patent Application Publication
(10) Pub. No.: US 2025/0332539 A1
(43) Pub. Date: Oct. 30, 2025

(54) CAPTURE AND RELEASE OF CARBON DIOXIDE USING ELECTROGENERATED ACIDS AND BASES

(71) Applicant: Eleryc, Inc., Campbell, CA (US)

(72) Inventors: Ian Robinson, San Jose, CA (US); David Koshy, San Mateo, CA (US); Sahag Voskian, Cambridge, MA (US); Kyle Weldon Self, San Jose, CA (US)

(73) Assignee: Eleryc, Inc., Campbell, CA (US)

(21) Appl. No.: 19/192,002

(22) Filed: Apr. 28, 2025

Related U.S. Application Data
(60) Provisional application No. 63/640,075, filed on Apr. 29, 2024.
(60) Provisional application No. 63/687,571, filed on Aug. 27, 2024.

(51) Int. Cl. B01D 53/14; C25B 1/01; C25B 3/01; C25B 9/23; C25B 15/08

(52) U.S. Cl. CPC B01D 53/1475; B01D 53/1425; B01D 53/1493; C25B 1/01; C25B 3/01; C25B 9/23; C25B 15/083; C25B 15/087; B01D 2257/504

(57) ABSTRACT

Systems and methods for capturing and releasing carbon dioxide at least in part via the electrochemical production of acids and/or bases are generally described. An aqueous input stream that includes a dissolved salt such as sodium chloride may be input into an electrolysis assembly to produce acidic and/or basic species. The basic species may promote capture of carbon dioxide (e.g., via direct air capture or from a point source). The acidic species may promote subsequent release of the carbon dioxide to form a carbon dioxide-rich stream. In some instances, at least some streams are concentrated and/or recycled, thereby improving overall system performance and/or efficiency.

### RELATED APPLICATIONS

This application claims priority under 35 U.S.C. § 119(e) to U.S. Provisional Patent Application No. 63/640,075, filed Apr. 29, 2024, and entitled “Capture and Release of Carbon Dioxide Using Electrogenerated Acids and Bases,” and to U.S. Provisional Patent Application No. 63/687,571, filed Aug. 27, 2024, and entitled “Capture and Release of Carbon Dioxide Using Electrogenerated Acids and Bases,” each of which is incorporated herein by reference in its entirety for all purposes.

### TECHNICAL FIELD

Systems and methods for capturing and releasing carbon dioxide at least in part via the electrochemical production of acids and/or bases are generally described.

### BACKGROUND

Capturing and, in some cases, releasing carbon dioxide can be an important process (e.g., for carbon mitigation). Accordingly, improved methods and systems for capturing and, in some cases, releasing carbon dioxide are desirable.

### SUMMARY

Systems and methods for capturing and releasing carbon dioxide at least in part via the electrochemical production of acids and/or bases are generally described. The subject matter of the present invention involves, in some cases, interrelated products, alternative solutions to a particular problem, and/or a plurality of different uses of one or more systems and/or articles.

In one aspect, methods for treating a gas stream comprising carbon dioxide are provided. In some embodiments, the method comprises: transporting an aqueous input stream to an electrolytic cell, the aqueous input stream comprising dissolved cations and dissolved anions, wherein the cations comprise metal cations and/or ammonium cations and are present at a concentration of greater than or equal to 0.1 M, and wherein the anions comprise halide ions, oxyanions, and/or conjugate bases of organic acids and are present at a concentration of greater than or equal to 0.1 M; applying an electrical potential difference across the electrolytic cell and performing one or more reactions to produce: a base-rich product solution comprising electrogenerated basic species and at least some of the cations; and an acid-rich product solution comprising electrogenerated acidic species and at least some of the anions; exposing at least some of the electrogenerated basic species to carbon dioxide from an input gas stream to generate: a carbon dioxide-lean output gas stream having a lower concentration of carbon dioxide than the input gas stream; and a capture stream comprising: at least some of the cations, and dissolved carbonate anions and/or dissolved bicarbonate anions formed from the carbon dioxide; and exposing at least some of the electrogenerated acidic species to at least some of the dissolved carbonate anions and/or dissolved bicarbonate anions to generate: a carbon dioxide-rich output gas stream having a higher concentration of carbon dioxide than the input gas stream; and a release stream comprising at least some of the dissolved cations and at least some of the dissolved anions. In some embodiments, the anions comprise halide ions, sulfate ions, nitrate ions, phosphate ions, borate ions, and/or conjugate bases of organic acids.

In some embodiments, the method comprises: transporting an aqueous input stream to an electrolytic cell, the aqueous input stream comprising dissolved cations and dissolved anions, wherein the cations comprise metal cations and/or ammonium cations and are present at a concentration of greater than or equal to 0.1 M, and wherein the anions comprise halide ions, oxyanions, and/or conjugate bases of organic acids and are present at a concentration of greater than or equal to 0.1 M; applying an electrical potential difference across the electrolytic cell and performing one or more reactions involving one or more components of the aqueous input stream to produce: a base-rich product solution comprising electrogenerated basic species; and an acid-rich product solution comprising electrogenerated acidic species; exposing at least some of the electrogenerated basic species to carbon dioxide from an input gas stream to generate: a carbon dioxide-lean output gas stream having a lower concentration of carbon dioxide than the input gas stream; and a capture stream comprising dissolved carbonate anions and/or dissolved bicarbonate anions formed from the carbon dioxide; exposing at least some of the electrogenerated acidic species to at least some of the dissolved carbonate anions and/or dissolved bicarbonate anions to generate: a carbon dioxide-rich output gas stream having a higher concentration of carbon dioxide than the input gas stream; and a release stream comprising at least some of the dissolved cations and at least some of the dissolved anions; and increasing the concentration of the at least some of the dissolved cations and the at least some of the dissolved anions in the release stream, thereby forming a concentrated release stream.

In some embodiments, the method comprises: transporting an aqueous input stream to an electrolytic cell; applying an electrical potential difference across the electrolytic cell and performing one or more reactions involving one or more components of the aqueous input stream to produce: a base-rich product solution produced by an oxygen reduction half-reaction, the base-rich product solution comprising electrogenerated basic species; and an acid-rich product solution produced by a hydrogen oxidation half-reaction, the acid-rich product solution comprising electrogenerated acidic species; exposing at least some of the electrogenerated basic species to carbon dioxide from an input gas stream to generate: a carbon dioxide-lean output gas stream having a lower concentration of carbon dioxide than the input gas stream; and a capture stream comprising dissolved carbonate anions and/or dissolved bicarbonate anions formed from the carbon dioxide; and exposing at least some of the electrogenerated acidic species to at least some of the dissolved carbonate anions and/or dissolved bicarbonate anions to generate a carbon dioxide-rich output gas stream having a higher concentration of carbon dioxide than the input gas stream.

In another aspect, methods for obtaining an alkali metal-containing material are provided. In some embodiments, the method comprises: transporting an aqueous input stream and a catholyte input stream to a two-compartment electrolytic cell comprising a catholyte chamber and an anolyte chamber separated by a cation-selective membrane, the aqueous input stream comprising alkali metal cations and non-hydroxide anions; and applying an electrical potential difference across the electrolytic cell and performing one or more reactions to produce: a base-rich product solution produced in the catholyte chamber, the base-rich product solution comprising electrogenerated basic species and at least some of the alkali metal cations, wherein the catholyte input stream is transported to the catholyte chamber; and an anolyte product solution produced by a hydrogen oxidation half-reaction in the anolyte chamber, wherein the aqueous input stream is transported to the anolyte chamber; wherein the catholyte input stream comprises at least a portion of the base-rich product solution.

In some embodiments, the method comprises: transporting an aqueous input stream to an electrolytic cell, the aqueous input stream comprising alkali metal cations and non-hydroxide anions; applying an electrical potential difference across the electrolytic cell and performing one or more reactions to produce: a base-rich product solution comprising electrogenerated basic species and at least some of the alkali metal cations; and an anolyte product solution produced by a hydrogen oxidation half-reaction and/or an oxygen evolution reaction in an anolyte chamber that receives at least some of the non-hydroxide anions, the hydrogen oxidation half-reaction and/or the oxygen evolution reaction resulting in the protonation of at least some of the non-hydroxide anions; and combining at least a portion of the anolyte product solution with a stream containing dissolved carbonate anions and/or dissolved bicarbonate anions to generate: a carbon dioxide-rich output gas stream comprising carbon dioxide; and a release stream containing at least some of the non-hydroxide anions.

In some embodiments, the method comprises: transporting an aqueous input stream to an anolyte chamber of a two-compartment electrolytic cell comprising a catholyte chamber and the anolyte chamber separated by a cation-selective membrane, the aqueous input stream comprising alkali metal cations and non-hydroxide anions; and applying an electrical potential difference across the electrolytic cell and performing one or more reactions to produce: a base-rich product solution comprising electrogenerated basic species and at least some of the alkali metal cations; and an anolyte product solution produced by a hydrogen oxidation half-reaction in the anolyte chamber, wherein the aqueous input stream is transported to the anolyte chamber, wherein the anolyte product solution comprises electrogenerated acidic species, wherein a concentration of the acidic species in the anolyte product solution is greater than a concentration of the acidic species in the aqueous input stream; wherein the aqueous input stream comprises at least a portion of the anolyte product solution.

In some embodiments, the method comprises transporting an aqueous input stream to an electrolytic cell, the aqueous input stream comprising alkali metal cations and non-hydroxide anions; applying an electrical potential difference across the electrolytic cell and performing one or more reactions to produce: a base-rich product solution comprising electrogenerated basic species and at least some of the alkali metal cations; and an anolyte product solution produced by a hydrogen oxidation half-reaction, the anolyte product solution comprising at least some of the non-hydroxide anions; and combining at least a portion of the base-rich product solution with a dilution stream, thereby forming a diluted base-rich product solution; wherein the aqueous input stream comprises at least a portion of the diluted base-rich product solution.

In another aspect, systems for treating a gas stream comprising carbon dioxide are provided. In some embodiments, the system comprises an electrolysis assembly comprising: an electrolytic cell comprising an anode and a cathode; one or more electrolysis assembly liquid inlets configured to supply dissolved ions to the anode and/or the cathode; a first electrolysis assembly liquid outlet; and a second electrolysis assembly liquid outlet; and a gas-liquid contact vessel comprising: a contact vessel gas inlet; a contact vessel liquid inlet fluidically connected to the first electrolysis assembly liquid outlet; a contact vessel gas outlet; and a contact vessel liquid outlet; wherein the one or more electrolysis assembly liquid inlets are fluidically connected to the second electrolysis assembly liquid outlet and the contact vessel liquid outlet.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic diagram of an example of a system for treating a gas stream comprising carbon dioxide, according to some embodiments;

FIG. 1B shows a schematic diagram of an example of a system for treating a gas stream comprising carbon dioxide, including one or more recycle streams, according to some embodiments;

FIG. 2A shows a schematic cross-sectional diagram of an electrolytic cell in which an aqueous input stream is transported to a catholyte chamber, according to some embodiments;

FIG. 2B shows a schematic cross-sectional diagram of an electrolytic cell in which an aqueous input stream is transported to an anolyte chamber, according to some embodiments;

FIG. 2C shows a schematic cross-sectional diagram of an electrolytic cell in which an aqueous input stream is transported to an electrolyte chamber, according to some embodiments;

FIG. 2D shows a schematic cross-sectional diagram of an electrolytic cell configured as an electrodialysis cell and comprising a bipolar membrane, according to some embodiments;

FIG. 2E shows a schematic cross-sectional diagram of an electrolytic cell configured as an electrodialysis cell and comprising a bipolar membrane, according to some embodiments;

FIG. 3 shows a schematic diagram of an example of a system for treating a gas stream comprising carbon dioxide using a two-chamber electrolytic cell, according to some embodiments;

FIG. 4 shows a schematic diagram of an example of a system for treating a gas stream comprising carbon dioxide using a two-chamber electrolytic cell, according to some embodiments;

FIG. 5 shows a schematic diagram of an example of a system for treating a gas stream comprising carbon dioxide using a three-chamber electrolytic cell, according to some embodiments;

FIG. 6 shows a schematic diagram of an example of a system for treating a gas stream comprising carbon dioxide using a two-chamber electrolytic cell, according to some embodiments;

FIG. 7 shows a schematic diagram of an example of a system for treating a gas stream comprising carbon dioxide using a two-chamber electrolytic cell, according to some embodiments;

FIG. 8 shows a schematic diagram of an example of a system for treating a gas stream comprising carbon dioxide using a two-chamber electrolytic cell, according to some embodiments;

FIG. 9 shows a schematic diagram of an example of a system for treating a gas stream comprising carbon dioxide using a three-chamber electrolytic cell, according to some embodiments;

FIG. 10 shows a schematic diagram of an example of a system for treating a gas stream comprising carbon dioxide using a two-chamber electrolytic cell, according to some embodiments;

FIG. 11 shows a schematic diagram of an example of system for obtaining an alkali-containing material comprising an electrolytic cell that receives an aqueous input stream comprising alkali cations and non-hydroxide anions, according to some embodiments; and

FIG. 12 shows a schematic diagram of an example of system for obtaining an alkali-containing material comprising an electrolytic cell that receives an aqueous input stream comprising alkali cations and non-hydroxide anions, according to some embodiments.

### DETAILED DESCRIPTION

Systems and methods for capturing and releasing carbon dioxide at least in part via the electrochemical production of acids and/or bases are generally described. An aqueous input stream that includes a dissolved salt such as sodium chloride may be input into an electrolysis assembly to produce acidic and/or basic species. The basic species may promote capture of carbon dioxide (e.g., via direct air capture or from a point source). The acidic species may promote subsequent release of the carbon dioxide to form a carbon dioxide-rich stream (e.g., pure or nearly pure carbon dioxide). In some instances, at least some streams are concentrated and/or recycled, thereby improving overall system performance and/or efficiency.

It can be advantageous to couple the electrochemical generation of acid and/or base streams from, for example, salt solutions (e.g., brine solutions) to the capture and, in some instances, release of carbon dioxide. The electrochemical generation of such acid and/or base streams can be performed, for example, using an electrolytic cell. It has been realized in the context of this disclosure that certain combinations of electrolysis assemblies and arrangements of streams and inputs (including streams containing salts such as sodium chloride) can promote a relatively efficient system for treating fluid streams containing carbon dioxide. It has been realized in the context of this disclosure that existing methods to capture and release carbon dioxide suffer from low efficiencies and high costs due to expensive methods of generating and regenerating capture materials. Certain aspects of this disclosure are directed to implementations of electrochemical cells (e.g., low-voltage electrochemical cells) to generate capture and release solutions, facilitated by a judicious selection of aqueous salt input and electrode reactions. In some instances, the recycling of at least a portion of the capture/release stream (e.g., including a concentrator) allows for reductions of costs for carbon dioxide capture.

Aspects of this disclosure are directed to systems and methods for treating a gas stream comprising carbon dioxide. The system may be configured to transport an aqueous input stream to an electrolysis assembly. An electrolysis product output from the electrolysis assembly may subsequently participate in the capture of carbon dioxide (e.g., by promoting dissolution of carbon dioxide and subsequent deprotonation of the carbonic acid formed to produce bicarbonate (HCO₃⁻) and/or carbonate (CO₃²⁻) anions). The bicarbonate and/or carbonate may subsequently react with other electrolysis products to regenerate gaseous carbon dioxide as a relatively concentrated carbon dioxide stream (e.g., by protonating carbonate and/or bicarbonate to form carbonic acid, which equilibrates to carbon dioxide).

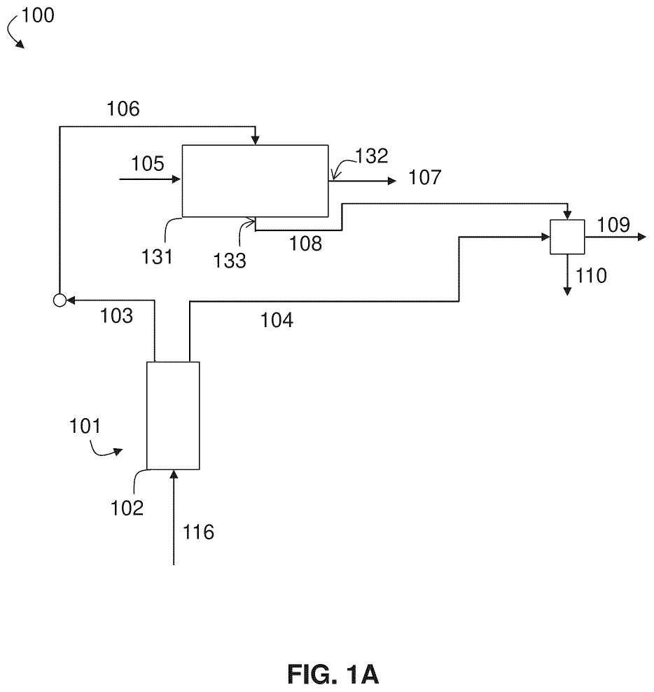

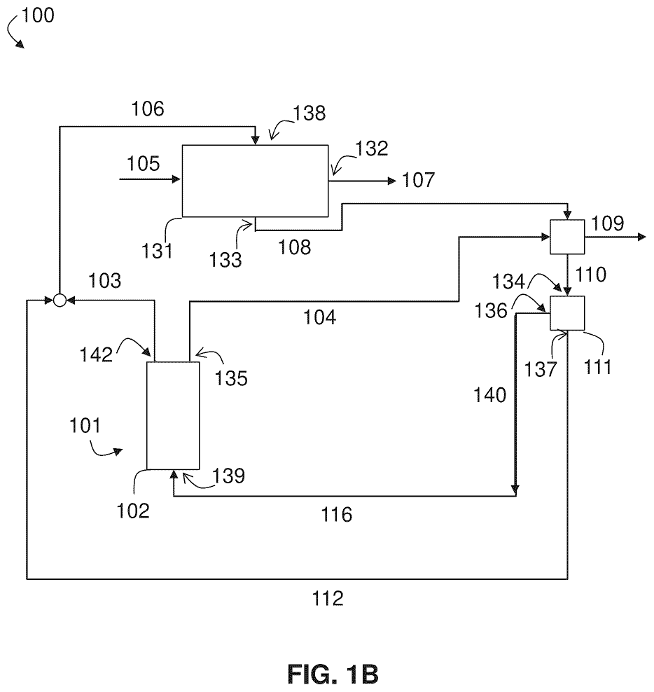

As an example, FIG. 1A shows a schematic diagram of system 100, which comprises electrolysis assembly 101 configured to receive aqueous input stream 116 (e.g., via one or more inlets). Electrolysis assembly may be fluidically connected to gas-liquid contact vessel configured to receive input gas stream 105 (e.g., a carbon dioxide-containing gas stream). Details of the components, connectivity, operation, and related chemistries of various embodiments are described in more detail below.

As noted above, in some embodiments, an aqueous input stream is transported to an electrolytic cell. The electrolytic cell may be part of an electrolysis assembly. For example, in FIG. 1A, aqueous input stream 116 is transported to an inlet of electrolysis assembly 101, which may include electrolytic cell 102, as discussed below. The aqueous input stream may be sourced and/or derived from any of a variety of streams, such as a brine, industrial effluent, streams from salt flats, streams rich in alkaline and/or alkali minerals (e.g., containing sulfides, sulfates, phosphates, nitrates, and/or chlorides), seawater, and/or wastewater. However, in some embodiments, the aqueous input stream is formulated for the purpose of generating base-rich and/or acid-rich product streams at least some of which may be suitable for participating in capture and/or release of carbon dioxide.

The aqueous input stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the aqueous input stream.

The aqueous input stream may include a relatively high concentration of dissolved salt. When a salt is dissolved, its constituents (e.g., a cation and an anion) may each be solvated (e.g., by solvent molecules such as water molecules) such that the constituents are no longer ionically bonded to each other. Accordingly, when referring to a dissolved or aqueous salt, the reference corresponds to the collection of dissolved constituents. The salt may promote relatively high conductivity within the electrolytic cell (e.g., by promoting charge neutrality as electrochemical reactions occur at and/or near electrode surfaces). Alternatively or additionally, the salt may promote high conductivity within the electrolytic cell by promoting charge transport (e.g., by promoting ion transport).

In some embodiments, the aqueous input stream comprises dissolved cations. Any of a variety of cations may be present. The cations may comprise monovalent cations (carrying a single positive charge). In some embodiments, the cations comprise metal cations. For example, the metal cations may comprises alkali metal ions. As a more specific example, the metal cations may comprise sodium ions (Na⁺) and/or potassium ions (K⁺). In some embodiments, the cations comprise ammonium cations (e.g., NH₄⁺ or a derivative thereof such as an alkylammonium). In some embodiments, the metal cations are spectator ions with respect to the chemistries employed by the electrolysis assembly and/or other reactions performed in the methods and systems of this disclosure.

In some embodiments, some (e.g., at least 0.3 mole percent (mol %), at least 1 mol %, at least 10 mol %, at least 20 mol %, at least 50 mol %, at least 75 mol %, at least 95 mol %, at least 98 mol %, at least 99 mol %) or all of the cations are alkali metal ions.

In some embodiments, some (e.g., at least 0.3 mole percent (mol %), at least 1 mol %, at least 10 mol %, at least 20 mol %, at least 50 mol %, at least 75 mol %, at least 95 mol %, at least 98 mol %, at least 99 mol %) or all of the cations are sodium ions and/or potassium ions.

In some embodiments, some (e.g., at least 0.3 mole percent (mol %), at least 1 mol %, at least 10 mol %, at least 20 mol %, at least 50 mol %, at least 75 mol %, at least 95 mol %, at least 98 mol %, at least 99 mol %) or all of the cations are sodium ions.

In some embodiments, some (e.g., at least 0.3 mole percent (mol %), at least 1 mol %, at least 10 mol %, at least 20 mol %, at least 50 mol %, at least 75 mol %, at least 95 mol %, at least 98 mol %, at least 99 mol %) or all of the cations are potassium ions.

As noted above, the cations may be present in the aqueous input stream at a relatively high concentration. In some embodiments, the dissolved cations are present in the aqueous input stream at a concentration of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible. It has been observed that, in some embodiments, a concentration of the cations of greater than or equal to 1 M and less than or equal to 6 M can contribute to desirable conductivity when operating the electrochemical cell.

In some embodiments, the aqueous input stream comprises dissolved anions. Any of a variety of anions may be present. In some embodiments, at least some of the anions are non-hydroxide anions. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates. In some embodiments, the monovalent anions comprise hydrogen sulfate ions (HSO₄⁻). In some embodiments, the monovalent anions comprise nitrites. In some embodiments, the monovalent anions comprise perchlorates. In some embodiments, the anions comprise divalent ions (carrying a charge of −2). For example, the anions may comprise sulfate ions (SO₄²⁻). In some embodiments, the anions comprise oxyanions. In some embodiments, the anions comprise phosphate ions (e.g., orthophosphate ions (PO₄³⁻), monohydrogen phosphate ions (HPO₄²⁻), and/or dihydrogen phosphate ions (H₂PO₄⁻)). In some embodiments, the anions comprise borate ions (e.g., orthoborate ions (BO₃³⁻), tetrahydroxyborates (B(OH)₄⁻), tetraborates (B₄O₇²⁻), and/or polyborates). In some embodiments, the anions include the conjugate base of an organic acid (e.g., a carboxylate-containing organic compound). Examples of conjugate bases of organic acids include, but are not limited to, formate, acetate, lactate, oxalate, and/or citrate. Another example of an organic acid is benzoic acid. In some embodiments, the anions referenced here do not include carbonate ions and/or bicarbonate ions (though one or both of carbonate anions and bicarbonate anions may also be present in the aqueous input stream in some embodiments). In some embodiments, the anions are conjugate bases of strong acids. However, in some embodiments, the anions (e.g., non-hydroxide anions) are conjugate bases of weak acids. In some embodiments, the anions are spectator ions with respect to the chemistries employed by the electrolysis assembly and/or other reactions performed in the methods and systems of this disclosure.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are non-hydroxide anions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are chloride ions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are phosphate ions (e.g., monohydrogen phosphate ions, dihydrogen phosphate ions, and/or dihydrogen phosphate ions). In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are dihydrogen phosphate ions.

As noted above, the anions may be present in the aqueous input stream in a relatively high concentration. In some embodiments, the dissolved anions are present in the aqueous input stream at a concentration of greater than or equal to 0.1 moles per liter (M), greater than or equal to 0.3 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6, M, up to 7 M, up to 8 M, up to 10 M, up to 20 M, or greater. Combinations of these ranges (e.g., greater than or equal to 0.1 M and up to 20 M, greater than or equal to 0.1 M and up to 10 M, greater than or equal to 0.3 M and up to 6 M) are possible.

In some embodiments, a dissolved alkali metal chloride is present in the aqueous input stream. For example, the aqueous input stream may comprise a dissolved alkali metal chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, up to 20 M, or greater. Combinations of these ranges are possible.

In some embodiments, dissolved sodium chloride is present in the aqueous input stream. For example, the aqueous input stream may comprise dissolved sodium chloride in an amount of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, or greater. Combinations of these ranges (e.g., greater than or equal to 0.1 M and less than or equal to 7 M, greater than or equal to 1 M and less than or equal to 6 M) are possible.

In some embodiments, dissolved potassium chloride is present in the aqueous input stream. For example, the aqueous input stream may comprise dissolved potassium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, a dissolved alkali orthophosphate (e.g., potassium orthophosphate and/or sodium orthophosphate) is present in the aqueous input stream. For example, the aqueous input stream may comprise dissolved alkali orthophosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible. In some embodiments, a dissolved alkali monohydrogen phosphate (e.g., potassium monohydrogen phosphate and/or sodium monohydrogen phosphate) is present in the aqueous input stream. For example, the aqueous input stream may comprise dissolved alkali monohydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible. In some embodiments, a dissolved alkali dihydrogen phosphate (e.g., potassium dihydrogen phosphate and/or sodium dihydrogen phosphate) is present in the aqueous input stream. For example, the aqueous input stream may comprise dissolved alkali dihydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible.

In some embodiments, dissolved carbonate anions are present in the aqueous input stream in addition to the other anions discussed above. For example, the aqueous input stream may comprise dissolved carbonate anions in an amount of greater than or equal to 0.005 M, greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

In some embodiments, dissolved bicarbonate anions are present in the aqueous input stream in addition to the other anions discussed above. For example, the aqueous input stream may comprise dissolved bicarbonate anions in an amount of greater than or equal to 0.01 M, greater than or equal to 0.02 M, greater than or equal to 0.05 M, greater than or equal to 0.1 moles per liter (M), greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

The aqueous input stream may have any of a variety of pH values, depending on the composition of the stream and the configuration of the system. The aqueous input stream may have a relatively low pH (e.g., in instances where acid (electrogenerated or otherwise) is present). In some embodiments, the aqueous input stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous input stream may have a relatively high pH (e.g., in instances where base (electrogenerated or otherwise) is present). In some embodiments, the aqueous input stream has a pH of greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

The electrolysis assembly may have any of a variety of configurations, depending on, for example, the arrangement of the overall system and/or the desired electrochemistries to be employed in electrogenerating basic and/or acidic species. Upon transport to the electrolysis assembly, one or more components of the aqueous input stream (e.g., dissolved species and/or solvent molecules such as water molecules) may undergo one or more electrochemically-induced reactions. The reactions may result, directly or indirectly, in the production of an acidic species and/or basic species. The acidic species and/or basic species may promote downstream capture and/or release of carbon dioxide.

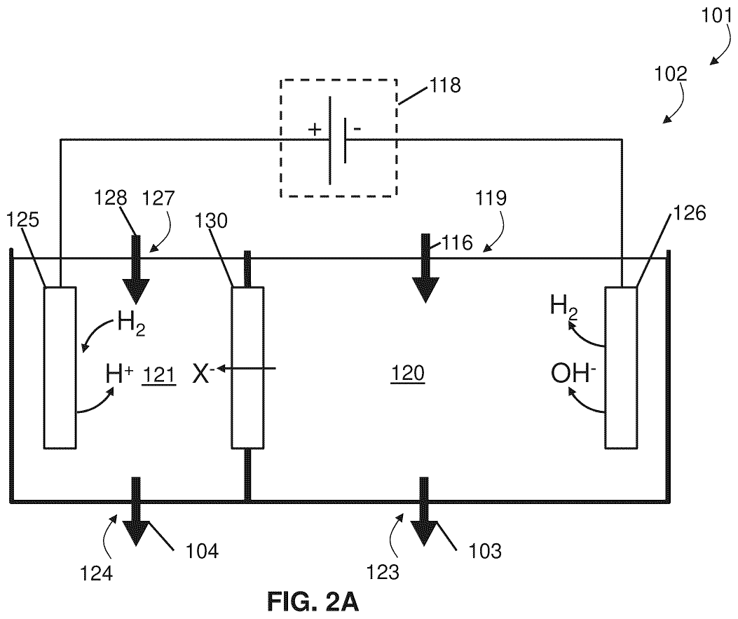

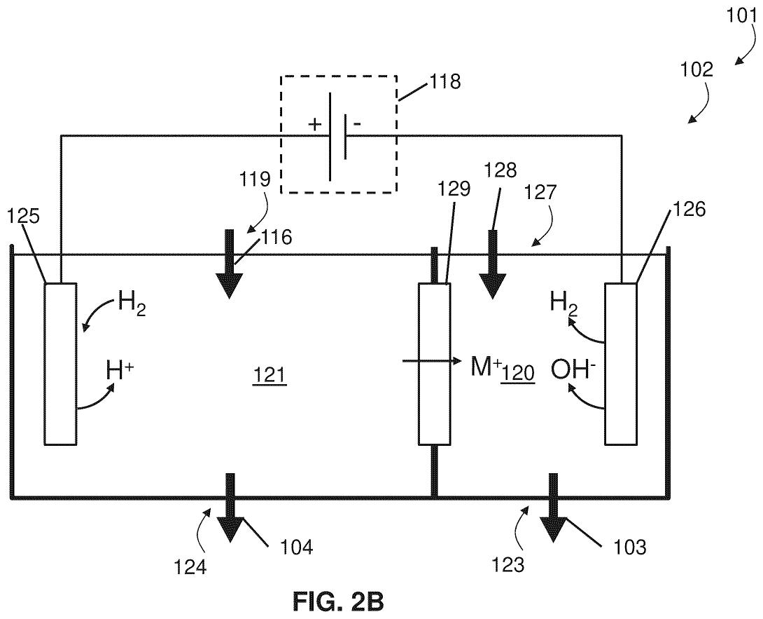

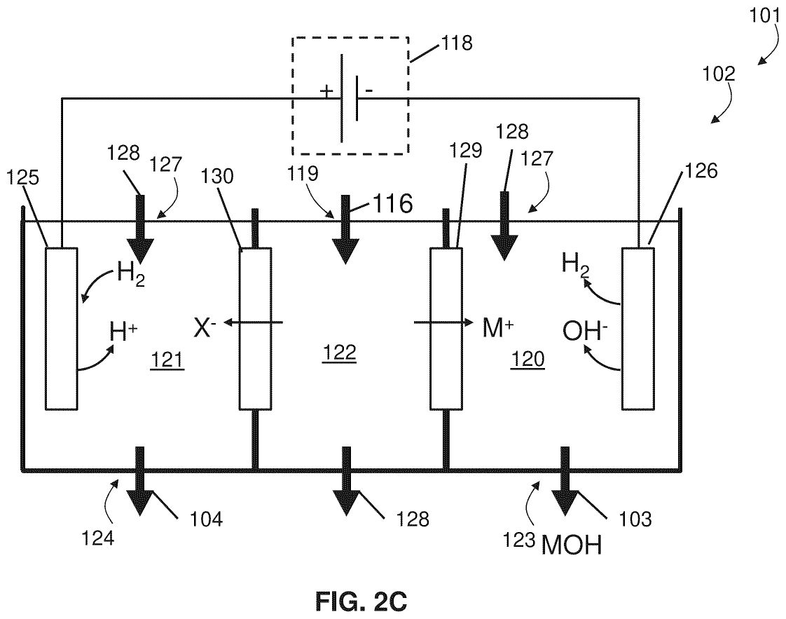

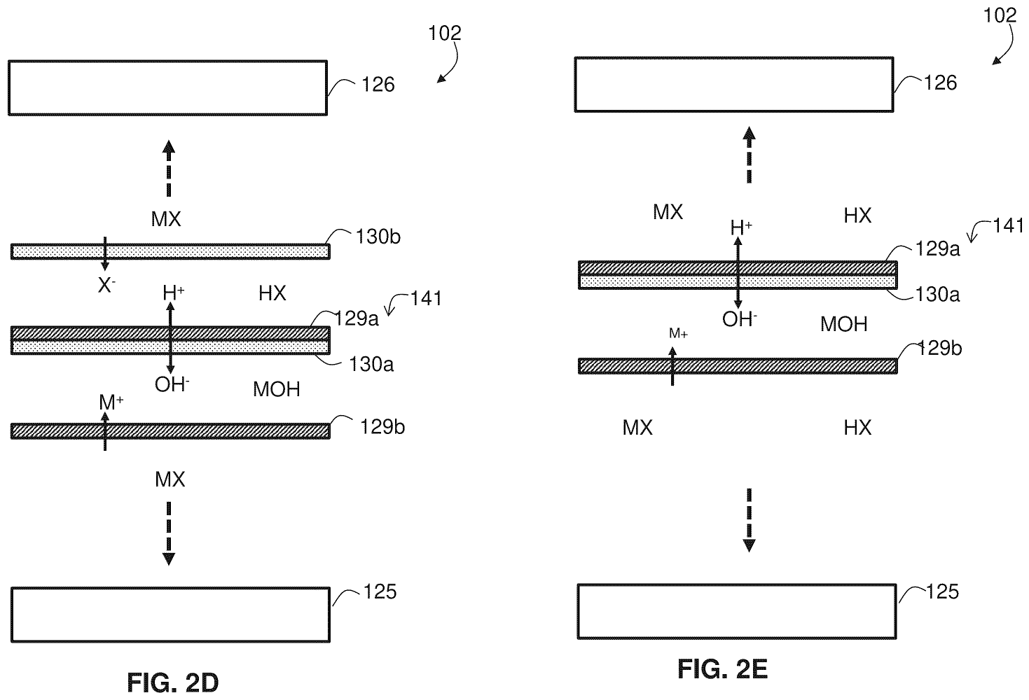

In some embodiments, the electrolysis assembly includes an electrolytic cell. FIGS. 2A-2C show cross-sectional schematic illustrations of non-limiting examples of embodiments of electrolytic assemblies 101 comprising electrolytic cell 102. An electrolytic cell generally comprises an anode and a cathode and is configured to use electrical energy to drive a chemical reaction that is thermodynamically non-spontaneous under the conditions of the reaction (e.g., temperature and pressure). The electrolytic cell may be a flow cell. The flow cell may be configured to receive one or more liquid streams (e.g., comprising reagents and/or electrolyte components). The flow cell may be configured to output one or more product streams comprising an electrogenerated product.

The embodiments in FIGS. 2A-2C use the hydrogen evolution and hydrogen reduction reactions as illustrative half reactions that can be employed in an overall chemical reaction that can be performed in the electrolytic cell. However, other chemistries (e.g., chloralkali chemistries) can also be employed.

While the electrolysis assemblies shown in FIGS. 2A-2C have a single electrolytic cell, some electrolysis assemblies may include multiple electrolytic cells (e.g., at least 2 cells, at least 3 cells, at least 4 cells, at least 5 cells, at least 10 cells, at least 50 cells, at least 100 cells, at least 500 cells, at least 1,000 cells, at least 5,000 cells, at least 10,000 cells, at least 15,000 cells, at least 25,000 cells, at least 50,000 cells, at least 100,000 cells, and/or up to 200,000 cells, up to 250,000 cells, up to 500,000 cells, up to 1,000,000 cells, or more). Combinations of these ranges (e.g., at least 2 cells and less than or equal to 1,000,000 cells, at least 15,000 cells and less than or equal to 25,000 cells) are possible. The multiple electrolytic cells may be fluidically arranged in parallel and/or in series.

The electrolytic cell may drive one or more reactions ultimately producing base-rich product solutions and acid-rich product solutions, as discussed below. The electrolytic cell may drive one or more of such reactions upon application of an electrical potential difference across the electrolytic cell. The potential difference may be applied across the anode and the cathode such that the thermodynamic barrier (and in some instances kinetic barrier) to the overall cell reaction is overcome, thereby initiating the cell reaction to occur via electron transfers that effect the respective half reactions. The magnitude of the electrical potential difference may be greater than or equal to 0.5 V, greater than or equal to 0.9 V, greater than or equal to 1.0 V, greater than or equal to 1.3 V, and/or up to 1.5 V, up to 1.8 V, up to 2 V, up to 2.5 V, up to 3 V, or higher. Combinations of these ranges (e.g., greater than or equal to 0.5 V and less than or equal to 3 V, greater than or equal to 0.9 and less than or equal to 1.5 V) are possible.

In FIGS. 2A-2C, for example, electrical potential difference 118 is applied across electrolytic cell 102 to initiate the chemical reactions shown.

In some embodiments, the electrolysis assembly includes one or more (e.g., at least one, at least two, at least three, or more) liquid inlets. The aqueous input stream may enter the electrolytic cell via one or more of these inlets. The liquid inlets may be configured to supply dissolved ions to the anode and/or the cathode. In some embodiments, one or more of the liquid inlets are part of the electrolytic cell itself, although in other embodiments, the liquid inlets are upstream of the cell (e.g., connected to a separate conduit that feeds the cell or an upstream unit operation within the assembly). In some embodiments, a single liquid inlet feeds both the anode and the cathode (and/or a third chamber between anolyte and catholyte chambers). However, in other embodiments, a first liquid inlet supplies dissolved ions to the cathode (e.g., as part of a catholyte solution) and a second liquid inlet supplies dissolved ions to the anode (e.g., as part of an anolyte solution).

In the embodiment shown in FIG. 2A, aqueous input stream 116 (e.g., comprising the dissolved cations and dissolved anions) is fed as catholyte into catholyte chamber 120 via liquid inlet 119 (and electrolyte solution 128 is fed as anolyte into anolyte chamber 121 via liquid inlet 127). In the embodiment shown in FIG. 2B, aqueous input stream 116 (e.g., comprising the dissolved cations and dissolved anions) is fed as anolyte into anolyte chamber 121 via liquid inlet 119 (and electrolyte solution 128 is fed as catholyte into catholyte chamber 120 via liquid inlet 127). In the embodiment shown in FIG. 2C, aqueous input stream 116 (e.g., comprising the dissolved cations and dissolved anions) is fed into electrolyte chamber 122 via liquid inlet 119 (and electrolyte solution 128 is fed as catholyte into catholyte chamber 120 via liquid inlet 127, and also electrolyte solution 128 is fed as anolyte into anolyte chamber 121 via liquid inlet 127).

In some embodiments, the electrolysis assembly includes two or more (e.g., at least two, at least three, or more) liquid outlets. The reaction products from one or more chemical reactions initiated by the application of the electrical potential difference may be output from the electrolysis assembly via these outlets. For example, the electrolysis assembly may include a first electrolysis assembly liquid outlet and a second electrolysis assembly liquid outlet.

The first electrolysis assembly liquid outlet may be configured to output a base-rich product solution (e.g., generated in a catholyte chamber). For example, the first electrolysis assembly liquid outlet may be in fluid communication with a catholyte chamber of the electrolytic cell. For example, in FIGS. 2A-2C, first liquid outlet 123 is in fluid communication with catholyte chamber 120 of electrolytic cell 102. At least a portion of base-rich product solution 103 generated by electrolysis assembly 101 may be output by first liquid outlet 123 (e.g., to a conduit to be transported to a downstream process and/or to be collected).

The second electrolysis assembly liquid outlet may be configured to output an acid-rich product solution (e.g., generated in an anolyte chamber). For example, the second electrolysis assembly liquid outlet may be in fluid communication with an anolyte chamber of the electrolytic cell. For example, in FIGS. 2A-2C, second liquid outlet 124 is in fluid communication with anolyte chamber 121 of electrolytic cell 102. At least a portion of acid-rich product solution 104 generated by electrolysis assembly 101 may be output by second liquid outlet 124 (e.g., to a conduit to be transported to a downstream process and/or to be collected). While the liquid outlets are shown as being directly part of electrolytic cell 102 in FIGS. 2A-2C, other configurations are possible. For example, while in some embodiments, one or more of the liquid outlets are part of the electrolytic cell itself, in other embodiments, the liquid outlets are downstream of the cell (e.g., connected to a separate conduit that feeds the downstream processes such as chambers or reactors for further reactivity (e.g., as in a chloralkali assembly in which hydrogen gas and chlorine gas electrolytic products are reacted to form HCl to produce the acid-rich product solution)).

As mentioned above, the electrolytic cell may comprise an anode and a cathode. In an electrolytic cell, the anode, also referred to as the positive electrode, is used to promote an electrochemical oxidation half reaction. For example, in the embodiments shown in FIGS. 2A-2C, anode 125 is configured to perform the hydrogen oxidation reaction, in which hydrogen gas is oxidized to form protons: ½ H₂→H⁺+e⁻ (with the electrons collected by anode 125 and transported to cathode 126 as part of the electrical circuit). Any of a variety of materials may be used for or as part of the anode, generally including an electronically conductive solid. In some embodiments, the anode comprises a conductive metal or metal alloy such as platinum, nickel, stainless steel, titanium, platinized titanium, silver, gold, or combinations thereof). In some embodiments, the anode is a gas diffusion electrode and/or comprises a gas diffusion layer (e.g., a carbon and/or metallic gas diffusion electrode and/or layer). In some embodiments, the anode comprises a catalyst configured to accelerate the reaction to occur at the anode (e.g., hydrogen oxidation). For example, the anode may comprise a platinum-group catalyst such as platinum. In some embodiments, the anode comprises a carbonaceous material (e.g., carbon black). The carbonaceous material may be combined with a polymer material (e.g., polytetrafluorethylene).

In some embodiments, the electrolytic cell comprises an anolyte chamber. The anolyte chamber may be in fluid communication with at least a portion of the anode (e.g., the anode may be at least partially submerged in anolyte that is present in the anolyte chamber). At least a portion (or all) of the anode may be located within the anolyte chamber. In the embodiments shown in FIGS. 2A-2C, anode 125 is submerged in anolyte in anolyte chamber 121.

In an electrolytic cell, the cathode, also referred to as the negative electrode, is used to promote an electrochemical reduction half reaction. For example, in the embodiments shown in FIGS. 2A-2C, cathode 126 is configured to perform the hydrogen evolution reaction, in which hydrogen gas is generated by the reduction of water (or protons from water): 2H₂O+2e⁻→H₂+2OH⁻ (with the electrons provided by cathode 126 after having been transported to cathode 126 from anode 125 as part of the electrical circuit). Any of a variety of materials may be used for the cathode, generally including an electronically conductive solid (e.g., a conductive metal or metal alloy such as platinum, nickel, ruthenium, stainless steel, or combinations thereof). As one example, the cathode may comprises nickel coated with a platinum group metal (e.g., platinum). However, in some embodiments, the cathode comprises a nickel substrate with a catalyst coating comprising a non-platinum group metal such as a non-platinum group transition metal. In some embodiments, the cathode comprises a catalyst configured to accelerate the reaction to occur at the cathode (e.g., hydrogen evolution).

In some embodiments where the hydrogen evolution reaction is performed at the cathode and the hydrogen oxidation reaction is performed at the anode, the hydrogen gas reactant at the anode is supplied from the product hydrogen gas generated at the cathode. For example, a conduit may be configured to collect hydrogen gas produced in the catholyte chamber and transport the hydrogen gas to the anolyte chamber for consumption.

In some embodiments, the electrolytic cell comprises a catholyte chamber. The catholyte chamber may be in fluid communication with at least a portion of the cathode (e.g., the cathode may be at least partially submerged in catholyte that is present in the catholyte chamber). At least a portion (or all) of the cathode may be located within the catholyte chamber. In the embodiments shown in FIGS. 2A-2C, cathode 126 is submerged in catholyte in catholyte chamber 120.

In some embodiments, the catholyte chamber and the anolyte chamber are separated by at least one separator (e.g., comprising a membrane and/or diaphragm). In some embodiments, the separator is not ion-selective. For example, the separator may comprise a porous media and separate the electrolyte compartments by limiting convective flow and/or molecular diffusion, without substantial (or any) ion selectivity. However, in some embodiments, the separator is ion-selective. For example, in some embodiments, the catholyte chamber and the anolyte chamber are separated by at least one ion-selective membrane (e.g., at least one ion-selective membrane, at least two ion selective membranes, or more). In this context, the separation refers to the membrane limiting or preventing transport of at least one type of ion from the catholyte chamber to the anolyte chamber or vice versa. Any of a variety of ion-selective membranes may be used. For example, the membrane may be a semi-permeable membrane (e.g., a semi-permeable polymer membrane, ceramic membrane, or combination thereof).

In some embodiments, at least one ion-selective membrane in the electrolytic cell comprises a cation-selective membrane. In some such embodiments, the aqueous input stream is transported to the anolyte chamber. For example, in the embodiment shown in FIG. 2B, aqueous input stream 116 comprising dissolved salt MX is transported to anolyte chamber 121 via liquid inlet 119, and cations M⁺ (e.g., sodium ions and/or potassium ions) migrate through cation-selective membrane 129 from anolyte chamber 121 to catholyte chamber 120. Cation M⁺ helps maintain charge neutrality and can be expelled from catholyte chamber 120 as part of base-rich product solution 103 (e.g., as a counter-cation to electrogenerated basic species such as hydroxide ions).

In some embodiments, at least one ion-selective membrane in the electrolytic cell comprises an anion-selective membrane. In some such embodiments, the aqueous input stream is transported to the catholyte chamber. For example, in the embodiment shown in FIG. 2A, aqueous input stream 116 comprising dissolved salt MX is transported to catholyte chamber 120 via liquid inlet 119, and anions X⁻ (e.g., halide ions such as chloride ions, sulfate ions, nitrate ions, phosphate ions) migrate through anion-selective membrane 130 from catholyte chamber 120 to anolyte chamber 121. Anion X⁻ helps maintain charge neutrality and can be expelled from anolyte chamber 121 as part of acid-rich product solution 104 (e.g., as a counter-anion to electrogenerated acidic species such as protons/hydronium ion or to other cations that may be present).

In some embodiments, the electrolytic cell further comprises an electrolyte chamber other than the catholyte chamber and the anolyte chamber. The electrolyte chamber may be separated from the catholyte chamber by a cation selective membrane. For example, in FIG. 2C, electrolyte chamber 122 is separated from catholyte chamber 120 by cation-exchange membrane 129, where cations M⁺ can migrate from electrolyte chamber 122 to catholyte chamber 120. In some embodiments, the electrolyte chamber is separated from the anolyte chamber by an anion exchange membrane. For example, in FIG. 2C, electrolyte chamber 122 is separated from anolyte chamber 121 by anion-exchange membrane 130, where anions X⁻ can migrate from electrolyte chamber 122 to anolyte chamber 121. In some embodiments in which there is an electrolyte chamber separated from the anolyte chamber and the catholyte chamber in the electrolytic cell, the aqueous input stream comprising dissolved salt is transported to that electrolyte chamber (e.g., via one of the electrolysis assembly inlets). For example, in FIG. 2C, aqueous input stream 116 comprising dissolved salt MX is fed to electrolyte chamber 122 via liquid inlet 119. In some embodiments, the electrolyte chamber is in fluid communication with a liquid outlet. For example, in some embodiments, an aqueous input stream comprising concentrated dissolved salt MX is transported via a liquid inlet to the electrolyte chamber, and an electrolyte outlet stream is output from the electrolyte chamber via a liquid outlet, with the electrolyte outlet stream having a lower concentration of dissolved MX than the aqueous input stream (e.g., by a factor of at least 1.01, at least 1.02, at least 1.05, at least 1.1, at least 1.2, at least, 1.5, at least 2, at least 5, at least 10, at least 20, and/or up to 50, up to 100, or more). Combinations of these ranges (e.g., at least 1.01 and less than or equal to 100, at least 1.01 and less than or equal to 5) are possible. As an illustrative example, if an electrolyte outlet stream has a concentration of dissolved MX of 0.2 M and the aqueous input stream has a concentration of MX of 1.0 M, then the electrolyte outlet stream has a concentration of MX that is lower than that of the aqueous input stream by a factor of 5 because 0.2 M times 5 equals 1.0 M.

Non-limiting examples of suitable electrolysis assembly and electrolytic cell configurations for at least some embodiments are described in U.S. Pat. No. 7,790,012 by Kirk et al., issued Sep. 7, 2010, which is incorporated herein by reference in its entirety for all purposes.

While the hydrogen evolution and hydrogen oxidation half-cell reactions are described in detail above and below, those reactions are illustrative, and other chemistries may be employed. For example, the electrolytic assembly may be configured to perform water electrolysis, where the hydrogen evolution reaction at the cathode is coupled to the oxygen evolution reaction at the anode. As another example, the electrolytic assembly may be configured to perform the oxygen reduction reaction at the cathode and one or more of the hydrogen oxidation reaction, the chlorine gas (Cl₂) evolution reaction, or the oxygen evolution reaction at the anode. As yet another example, the electrolytic assembly may be configured to perform a carbon dioxide reduction at the cathode and the oxygen evolution reaction at the anode.

In some embodiments, the electrolysis cell is configured to be operated as an electrodialysis cell. The cathode electrolysis and anode electrolysis half-reactions in an electrolytic cell configured as an electrodialysis cell may create electric fields that drive separation of cations and anions (e.g., using semi-permeable membranes such as ion-selective membranes). In some embodiments, the electrolytic cell comprises a cathode, an anode, and two or more semi-permeable membranes (e.g., two or more ion-selective membranes) separating the cathode and the anode. In some embodiments, the electrolysis cell comprises a bipolar membrane as at least one of the semi-permeable membranes. A bipolar membrane may comprise an anion-selective membrane layer and a cation-selective membrane layer configured to create a junction at an interface between the anion-selective membrane layer and the cation-selective membrane layer (e.g., upon being pressed together). The bipolar membrane may be configured to promote dissociation of water at the junction to form protons (e.g., as hydronium cations) and hydroxide anions. In some, but not necessarily all embodiments, the bipolar membrane comprises a water dissociation catalyst, which may enhance the rate of water dissociation.

FIG. 2D shows a schematic cross-sectional diagram of an embodiment in which electrolytic cell 102 is configured as an electrodialysis cell comprising bipolar membrane 141. Application of an electrical potential difference across electrolytic cell 102 may initiate a cathode electrolysis half reaction at cathode 126 and an anode half reaction at anode 125 of electrolytic cell 102. The cathode electrolysis half reaction may generate negative charge near cathode 126, thereby generating an electric field attracting cations. The anode electrolysis half reaction may generate positive charge near anode 125, thereby generating an electric field attracting anions. Bipolar membrane 141 comprises cation-selective membrane 129a and anion-selective membrane 130a configured to dissociate water into H⁺ and OH⁻. The dissociated H⁺ may diffuse from cation-selective membrane 129a of bipolar membrane 141 toward cathode 126, while the dissociated OH⁻ may diffuse from anion-selective membrane 130a toward anode 125. Additionally, anion-selective membrane 130b may separate cation-selective membrane 129a and cathode 126, thereby reducing or stopping transport of the diffusing H⁺ toward cathode 126 while permitting dissolved anion X⁻ from dissolved salt MX (e.g., NaCl) to cross anion-selective membrane 130b in the opposite direction. As a result, a product solution comprising dissolved HX may be formed in the space between anion-selective membrane 130b and cation-selective membrane 129a. Such a product solution may form some or all of an anolyte product stream (e.g., an acid-rich product stream) output by electrolytic cell 102.

Meanwhile, in FIG. 2D, cation-selective membrane 129b may separate anion-selective membrane 130a and anode 125, thereby reducing or stopping transport of the diffusing OH toward anode 125 while permitting dissolved metal cation M⁺ from dissolved salt MX (e.g., NaCl) to cross cation-selective membrane 129b in the opposite direction. As a result, a product solution comprising dissolved MOH may be formed in the space between cation-selective membrane 129b and anion-selective membrane 130a. Such a product solution may form some or all of base-rich product stream output by electrolytic cell 102.

FIG. 2E shows a schematic cross-sectional illustration of another embodiment in which electrolytic cell 102 is configured as an electrodialysis cell, but without use of a separate anion-selective membrane in addition to that in bipolar membrane 141. As before, the dissociated H⁺ may diffuse from cation-selective membrane 129a of bipolar membrane 141 toward cathode 126, while the dissociated OH⁻ may diffuse from anion-selective membrane 130a toward anode 125. The diffusing H⁺ may become exposed to solution comprising X⁻ from dissolved salt MX (e.g., NaH₂PO₄). As a result, a product solution comprising dissolved HX (e.g., H₃PO₄) may be formed on the side of cation-selective membrane 129a closest to cathode 126. Such a product solution may form some or all of an anolyte product stream (e.g., an acid-rich product stream) output by electrolytic cell 102.

Meanwhile, in FIG. 2E, cation-selective membrane 129b may separate anion-selective membrane 130a and anode 125, thereby reducing or stopping transport of the diffusing OH⁻ toward anode 125 while permitting dissolved metal cation M⁺ from dissolved salt MX (e.g., NaH₂PO₄) to cross cation-selective membrane 129b in the opposite direction. As a result, a product solution comprising dissolved MOH (e.g., NaOH) may be formed in the space between cation-selective membrane 129b and anion-selective membrane 130a. Such a product solution may form some or all of base-rich product stream output by electrolytic cell 102.

The arrangements of ion-selective membranes shown in FIGS. 2D-2E may be repeated any of a variety of times to form a stack between the cathode, which may be at one end of a stack, and the anode, which may be at the opposite end of the stack.

In some embodiments, the cathode electrolysis half reaction of the electrodialysis cell is the hydrogen evolution reaction. In some embodiments, the cathode electrolysis half reaction of the electrodialysis cell is the oxygen reduction reaction. In some embodiments, the cathode electrolysis half reaction of the electrodialysis cell is a carbon dioxide reduction reaction. In some embodiments, the anode electrolysis half reaction of the electrodialysis cell is the hydrogen oxidation reaction. In some embodiments, the anode electrolysis half reaction of the electrodialysis cell is the oxygen evolution reaction. In some embodiments, the cathode electrolysis half reaction of the electrodialysis cell is the hydrogen evolution reaction and the anode electrolysis half reaction is the oxygen evolution reaction. In some embodiments, the cathode electrolysis half reaction of the electrodialysis cell is the hydrogen evolution reaction and the anode electrolysis half reaction is the hydrogen oxidation reaction. In some embodiments, the cathode electrolysis half reaction of the electrodialysis cell is the oxygen reduction reaction and the anode electrolysis half reaction is the oxygen evolution reaction. In some embodiments, the cathode electrolysis half reaction of the electrodialysis cell is a carbon dioxide reduction reaction and the anode electrolysis half reaction is the oxygen evolution reaction. In some embodiments, the cathode electrolysis half reaction of the electrodialysis cell is the oxygen reduction reaction and the anode electrolysis half reaction is the hydrogen oxidation reaction.

In some embodiments, the cathode electrolysis half reaction of the electrolytic cell (e.g., in the catholyte chamber) is the hydrogen evolution reaction. In some embodiments, the cathode electrolysis half reaction of the electrolytic cell (e.g., in the catholyte chamber) is the oxygen reduction reaction. In some embodiments, the cathode electrolysis half reaction of the electrolytic cell (e.g., in the catholyte chamber) is a carbon dioxide reduction reaction. In some embodiments, the anode electrolysis half reaction of the electrolytic cell (e.g., in the anolyte chamber) is the hydrogen oxidation reaction. In some embodiments, the anode electrolysis half reaction of the electrolytic cell (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the hydrogen oxidation reaction. In some embodiments, the cathode electrolysis half reaction of the electrolytic cell (e.g., in the catholyte chamber) is the oxygen reduction reaction and the anode electrolysis half reaction (e.g., in the anolyte chamber) is the oxygen evolution reaction. In some embodiments, the cathode electrolysis half reaction of the electrolytic cell (e.g., in the catholyte chamber) is a carbon dioxide reduction reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the oxygen reduction reaction and the anode electrolysis half reaction (e.g., in the anolyte chamber) is the hydrogen oxidation reaction. In some such embodiments, employing the oxygen reduction reaction and the hydrogen oxidation reaction as the respective half-reactions in the cathode and anode can facilitate the generation of electricity in a system capable of capturing and in some instances releases carbon dioxide.

As discussed above, a base-rich product solution may be formed as a result of the one or more reactions performed via the electrolytic cell. For example, in FIG. 1A, at least a portion of base-rich product solution is output from electrolysis assembly 101 as stream 103. The base-rich product solution may be formed, for example, in the catholyte chamber of the electrolytic cell. The base-rich product solution may be formed using a batch, semi-batch, or continuous process involving the electrolytic cell.

The base-rich product solution may comprise electrogenerated basic species. The electrogenerated basic species may be dissolved in an aqueous solution. The electrogenerated basic species may be a direct or indirect product of the one or more chemical reactions performed in the electrolysis assembly. The electrogenerated basic species may be a source of alkalinity for the solution. For example, the electrogenerated basic species may be a species whose conjugate acid has a relatively high pKₐ. The basic species may have a conjugate acid having a pKₐ of greater than or equal to 10, greater than or equal to 10.3, greater than or equal to 10.5, greater than or equal to 11, greater than or equal to 12, greater than or equal to 14, greater than or equal to 15, and/or up to 15.7, up to 16, or greater in water at a temperature of 298 K. Combinations of these ranges are possible. In some embodiments, the electrogenerated basic species comprises hydroxide ions (OH⁻). One way in which the hydroxide ions may be generated is from the hydrogen evolution reaction (e.g., in the catholyte chamber). As another example, the electrogenerated species may comprise carbonate ions (CO₃²⁻). The carbonate ions may be generated from deprotonation of dissolved carbonic acid (from dissolved carbon dioxide) by electrogenerated hydroxide ions, either in the catholyte chamber or in a different component of the system.

The basic species (e.g., hydroxide ions) may be present in the base-rich product solution in a relatively high concentration (which may promote effective carbon dioxide capture elsewhere in the system). It should be understood that the name “base-rich product solution” is used for convenience in identifying the solution, and is not meant to imply any particular absolute or relative concentration of base in the solution. In some embodiments, the basic species (e.g., hydroxide ions) is present in the base-rich product solution at a concentration of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, or greater than or equal to 1 M and less than or equal to 10 M) are possible. In some embodiments, the molar ratio of the concentration of the basic species (e.g., hydroxide ions) in the base-rich product solution to the concentration of the basic species in the stream fed to the catholyte compartment (e.g., the aqueous input stream or a different electrolyte stream) is at least 1.005, at least 1.01, at least 1.05, at least 1.1, at least 1.2, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, base-rich product solution has a relatively high pH. For example, in some embodiments, the base-rich product solution has a pH of greater than or equal to 8, greater than or equal to 9, greater than or equal to 10, greater than or equal to 11, greater than or equal to 12, greater than or equal to 13, greater than or equal to 14, and/or up to 15, up to 16, or greater. Combinations of these ranges are possible.

In some embodiments, the base-rich product solution comprises at least some of the cations (e.g., the metal cations and/or ammonium cations discussed above). The cations may be from the aqueous input stream. The cations in the base-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the cations in the aqueous input stream. For example, an aqueous input solution comprising dissolved MX (e.g., NaCl) may be transported to the electrolytic cell, and a base-rich product solution comprising dissolved MOH (e.g., NaOH) may be produced by the electrolytic cell.

As discussed above, an acid-rich product solution may be formed as a result of the one or more reactions performed via the electrolytic cell. For example, in FIG. 1A, at least a portion of acid-rich product solution is output from electrolysis assembly 101 as stream 104. The acid-rich product solution may be formed, for example, in the anolyte chamber of the electrolytic cell. The acid-rich product solution may be formed using a batch, semi-batch, or continuous process involving the electrolytic cell.

The acid-rich product solution may comprise electrogenerated acidic species. The electrogenerated acidic species may be dissolved in an aqueous solution. The electrogenerated acidic species may be a direct or indirect product of the one or more chemical reactions performed in the electrolysis assembly. The electrogenerated acidic species may be a source of acidity for the solution. For example, the electrogenerated acidic species may have a relatively low pKₐ. The acidic species may have a pKₐ of less than or equal to 7, less than or equal to 6, less than or equal to 5, less than or equal to 4, less than or equal to 3, less than or equal to 2.5, less than or equal to 2, less than or equal to 1, less than or equal to 0, less than or equal to −1, and/or as low as −1.7, as low as −2, or less in water at a temperature of 298 K. Combinations of these ranges are possible. In some embodiments, the electrogenerated acidic species comprises hydronium ions (H₃O⁺). One way in which the hydronium ions may be generated is from the hydrogen oxidation reaction (e.g., in the anolyte chamber). The protons generated by the hydrogen oxidation reaction protonate water molecules, thereby forming the hydronium ions. As another example, the electrogenerated acidic species may comprise a weak acid. The weak acid may be, for example, an organic weak acid. Examples of organic weak acids include, but are not limited to acetic acid, acrylic acid, benzoic acid, chloroacetic acid, citric acid, dichloroacetic acid, formic acid, hexanoic acid, maleic acid, malic acid, malonic acid, heptanoic acid, octanoic acid, oxalic acid, phthalic acid, picric acid, succinic acid, and/or trichloroacetic acid. In some embodiments, the weak acid is an inorganic weak acid. Examples of inorganic weak acids include, but are not limited to boric acid, chromic acid, perchloric acid, periodic acid, phosphoric acid, dihydrogen phosphate (e.g., as dissolved alkali dihydrogen phosphate such as dissolved potassium dihydrogen phosphate), pyrophosphoric acid, sulfurous acid, and/or tetraboric acid.

The weak acid may be a weak Bronsted Lowry acid present in its protonated form but with a sufficiently high acidity to ultimately drive acid-base equilibria for carbon dioxide release (e.g., in a downstream process). For example, the acidic species may comprise phosphoric acid (H₃PO₄). The phosphoric acid may be generated from protonation of dissolved dihydrogen phosphate by electrogenerated hydronium ions, either in the anolyte chamber or in a different component of the system. As another example, the acidic species may comprise dihydrogen phosphate (H₂PO₄). The dihydrogen phosphate may be generated from protonation of dissolved monohydrogen phosphate by electrogenerated hydronium ions, either in the anolyte chamber or in a different component of the system. As yet another example, the acidic species may comprise boric acid (H₃BO₃). The boric acid may be generated from protonation of dissolved dihydrogen borate by electrogenerated hydronium ions, either in the anolyte chamber or in a different component of the system. As yet another example, the acidic species may comprise acetic acid. The acetic acid may be generated from protonation of dissolved acetate by electrogenerated hydronium ions, either in the anolyte chamber or in a different component of the system. As yet another example, the acidic species may comprise benzoic acid. The benzoic acid may be generated from protonation of dissolved benzoate by electrogenerated hydronium ions, either in the anolyte chamber or in a different component of the system. As yet another example, the acidic species may comprise formic acid. The formic acid may be generated from protonation of dissolved formate by electrogenerated hydronium ions, either in the anolyte chamber or in a different component of the system.

The acidic species (e.g., hydronium ions) may be present in the acid-rich product solution in a relatively high concentration (which may promote effective carbon dioxide release in the electrolytic cell and/or elsewhere in the system). It should be understood that the name “acid-rich product solution” is used for convenience in identifying the solution, and is not meant to imply any particular absolute or relative concentration of acid in the solution. In some embodiments, the acidic species (e.g., hydronium ions) is present in the acid-rich product solution at a concentration of greater than or equal to 0.000001 M, greater than or equal to 0.00001 M, greater than or equal to 0.0001 M, greater than or equal to 0.001 M, greater than or equal to 0.01 M, greater than or equal to 0.02 M greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, the acidic species (e.g., hydronium ions) is present in the acid-rich product solution at a concentration of greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.05 M and less than or equal to 3 M, greater than or equal to 0.1 and less than or equal to 2 M) are possible. Another example of a combination of these ranges is greater than or equal to 0.000001 M and less than or equal to 3 M. In some embodiments, the molar ratio of the concentration of the acidic species (e.g., hydronium ions) in the acid-rich product solution to the concentration of the acidic species in the stream fed to the anolyte compartment (e.g., the aqueous input stream or a different electrolyte stream) is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, acid-rich product solution has a relatively low pH. For example, in some embodiments, the acid-rich product solution has a pH of less than or equal to 6, less than or equal to 5, less than or equal to 4, less than or equal to 3, less than or equal to 2, less than or equal to 1, less than or equal to 0, and/or as low as −1, as low as −2, or lower. Combinations of these ranges are possible.

In some embodiments, the acid-rich product solution comprises at least some of the anions (e.g., the halide, sulfate, nitrate, and/or phosphate anions discussed above). The anions may be from the aqueous input stream. For example, the anions in the acid-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the anions in the aqueous input stream. For example, an aqueous input solution comprising dissolved MX (e.g., NaCl) may be transported to the electrolytic cell, and an acid-rich product solution comprising dissolved HX (e.g., HCl) may be produced by the electrolytic cell.

In some embodiments, carbon dioxide from an input gas stream is captured. The capture of the carbon dioxide may be induced by exposure of the carbon dioxide to a relatively high pH solution. For example, in some embodiments, at least some (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up 99 mol %, or all) of the electrogenerated basic species from the base-rich product solution are exposed to carbon dioxide from the input gas stream. This exposure may result in the generation of a carbon dioxide-lean gas stream and a capture stream, as discussed below. As an example, in FIG. 1A, contact vessel liquid inlet stream 106 comprising at least a portion (e.g., at least 5 mol %, at least 10 mol %, at least 25 mol %, at least 50 mol %, at least 75 mol %, at least 90 mol %, at least 95 mol %, at least 98 mol %, at least 99 mol %, or more) of base-rich product solution 103 and input gas stream 105 are each input into gas-liquid contact vessel 131, where the presence of the electrogenerated basic species induces, via one or more acid-base equilibrium reactions, the removal of carbon dioxide from input gas stream 105 to form the carbon dioxide-lean output gas stream 107 and capture stream 108.

The acid-base equilibria driving removal of carbon dioxide via exposure of carbon dioxide to the basic species may proceed as follows:

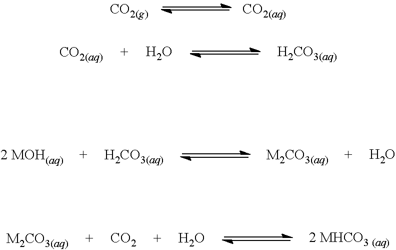

where MOH corresponds to dissolved cation and hydroxide. Here, the hydroxide drives deprotonation of carbonic acid to form carbonate ions thereby converting carbon dioxide from a gas to a dissolved species in a liquid solution. Alternatively or additionally, carbonate ions (generated by the above equilibria and/or from the base-rich product solution) may drive similar equilibria to form bicarbonate ions. It should be understood that while the chemical reactions shown above include double arrows for equilibrium reactions and are referred to in various places of this disclosure as acid-base equilibria, the methods described in this disclosure may be operated under conditions such that some or all of these reactions proceed without being at chemical equilibrium (e.g., due to mass transfer of species between different phases).

Any of a variety of gas streams may be employed as the input gas stream. In some embodiments, the input gas stream is or is derived from air (e.g., ambient air). In such a way, the methods and systems of this disclosure may be used to perform direct air capture of carbon dioxide. In some embodiments, the input gas is from a point source of carbon dioxide (e.g., industrial effluent). The point source of carbon dioxide may be a single location (e.g., a power plant, factory, and/or industrial facility) that emits carbon dioxide, as opposed to diffuse, atmospheric carbon dioxide present in ambient air. For example, the input gas stream may comprise or be derived from flue gas. In such a way, the methods and systems of this disclosure may be used to perform direct carbon capture. In some embodiments, the point source comprises a power plant, a cement production facility, a steel production facility, an aluminum production facility, a steam methane reforming facility, an autothermal reforming facility, a natural gas wellhead, a natural gas pipeline, a paper mill, and/or a Haber-Bosch facility (which catalytically produces NH₃ from H₂ and N₂). While the input gas stream may be referred to as a stream, this is not to imply any particular flow rate or type of flow path for the stream. For example, the system may intake gas (e.g., ambient air) surrounding the system, and/or or gas may be flowed (e.g., at ambient or an elevated pressure) through a conduit into, for example, the gas-liquid contact vessel.

In some embodiments, the input gas stream comprises carbon dioxide in an amount of less than or equal to 200,000 ppm. In some embodiments, the input gas stream comprises carbon dioxide in an amount of less than or equal to 100,000 ppm, less than or equal to 50,000 ppm, less than or equal to less than or equal to 20,000 ppm, less than or equal to 10,000 ppm, less than or equal to 5,000 ppm, less than or equal to 1,000 ppm, less than or equal to 600 ppm, less than or equal to 500 ppm, and/or as low as 400 ppm, as low as 300 ppm, as low as 100 ppm, or less by volume. Combinations of these ranges (e.g., less than or equal to 100,000 ppm and as low as 100 ppm, or less than or equal to 1,000 ppm and as low as 100 ppm) are possible.

In some embodiments (e.g., where the method is performed for direct air capture), the input gas stream comprises carbon dioxide at a partial pressure of less than or equal to 0.5 bar, less than or equal to 0.2 bar, less than or equal to 0.1 bar, less than or equal to 0.05 bar, less than or equal to 0.02 bar, less than or equal to 0.01 bar, less than or equal to 0.005 bar, less than or equal to 0.002 bar, less than or equal to 0.001 bar, and/or as low as 0.0005 bar, as low as 0.0002 bar, as low as 0.0001 bar, or less. Combinations of these ranges (e.g., less than or equal to 0.5 bar and as low as 0.0001 bar) are possible. In some embodiments (e.g., where the method is performed for point source carbon capture), the input gas stream comprises carbon dioxide at a partial pressure of greater than or equal to 0.002 bar, greater than or equal to 0.005 bar, greater than or equal to 0.01 bar, greater than or equal to 0.02 bar, greater than or equal to 0.05 bar, greater than or equal to 0.1 bar, greater than or equal to 0.2 bar, greater than or equal to 0.5 bar, greater than or equal to 1 bar, greater than or equal to 2 bar, greater than or equal to 5 bar, greater than or equal to 10 bar, and/or up to 20 bar, up to 30 bar, up to 40 bar, or more. Combinations of these ranges (e.g., greater than or equal to 0.002 bar and less than or equal to 40 bar) are possible.

As noted above, the interaction between the carbon dioxide and the basic species (e.g., via one or more acid-base equilibrium reactions) may produce a carbon dioxide-lean output gas stream. For example, in FIG. 1A, carbon dioxide-lean output gas stream 107 may be output from contact vessel gas outlet 132 of gas-liquid contact vessel 131. The carbon dioxide-lean gas outlet stream may have a relatively low concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the carbon dioxide-lean output gas stream comprises carbon dioxide in an amount of less than or equal to 50,000 ppm, less than or equal to 25,000 ppm, less than or equal to 20,000 ppm, less than or equal to 10,000 ppm, less than or equal to 5,000 ppm, less than or equal to 1,000 ppm, less than or equal to 600 ppm, less than or equal to 500 ppm, less than or equal to 400 ppm, less than or equal to 300 ppm, less than or equal to 200 ppm, less than or equal to 100 ppm, less than or equal to 50 ppm, less than or equal to 20 ppm, less than or equal to 10 ppm, less than or equal to 5 ppm, less than or equal to 1 ppm, and/or as low as 0.5 ppm, as low as 0.1 ppm, as low as 0.01 ppm, or less by volume. Combinations of these ranges (e.g., greater than or equal to 0.01 ppm and less than or equal to 50,000 ppm, or greater than or equal to 1 ppm and less than or equal to 25,000 ppm) are possible.

The carbon dioxide-lean output gas stream may have a lower concentration of carbon dioxide than the input gas stream. In some embodiments, a relatively high percentage of carbon dioxide in the input gas stream is removed in forming the carbon dioxide-lean output gas stream. For example, in some embodiments, a molar ratio of the concentration of carbon dioxide in the input gas stream to the concentration of carbon dioxide in the carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible.

In some embodiments, the carbon dioxide-lean output gas stream is discharged from the system. However, in other embodiments, the carbon dioxide-lean output gas stream is transported to a different component of the system for further treatment (e.g., removal of additional contaminants and/or combination with other streams).

In some embodiments, the interaction between the carbon dioxide and the basic species (e.g., via one or more acid-base equilibrium reactions) produces a capture stream. For example, in FIG. 1A, capture stream 108 may be output from contact vessel liquid outlet 133 of gas-liquid contact vessel 131. The capture stream may comprise captured carbon dioxide in the form of, for example, dissolved carbonate anions and/or dissolved bicarbonate anions formed from carbon dioxide (e.g., upon exposure to electrogenerated alkalinity in the form of basic species). The capture stream may have a relatively high concentration of dissolved carbonate anions. For example, in some embodiments, the capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of carbonate anions while the capture stream comprises carbonate anions. In some embodiments in which the base-rich product solution comprises carbonate anions, the molar ratio of the concentration of carbonate anions in the capture stream to the concentration of carbonate anions in the stream to which the carbon dioxide is exposed (e.g., the contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

The capture stream may have a relatively high concentration of dissolved bicarbonate anions. For example, in some embodiments, the capture stream comprises dissolved bicarbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of bicarbonate anions while the capture stream comprises bicarbonate anions. In some embodiments in which the base-rich product solution comprises bicarbonate anions, the molar ratio of the concentration of bicarbonate anions in the capture stream to the concentration of bicarbonate anions in the stream to which the carbon dioxide is exposed (e.g., the contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments, capture stream has a relatively high pH. For example, in some embodiments, the capture stream has a pH of greater than or equal to 7, greater than or equal to 8, greater than or equal to 9, greater than or equal to 10, greater than or equal to 11, greater than or equal to 12, and/or up to 13, up to 14, or greater. Combinations of these ranges are possible.

In some embodiments, the capture stream comprises at least some of the cations (e.g., the metal cations and/or ammonium cations discussed above). The cations may be from the base-rich product solution. For example, the cations in the capture stream may constitute at least a portion (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up to 99 mol %, or all) of the cations in the base-rich product solution. For example, a contact vessel inlet stream comprising dissolved MOH (e.g., NaOH) may be transported to the contact vessel, and a capture stream comprising dissolved M₂CO₃ (e.g., Na₂CO₃) and/or dissolved MHCO₃ (e.g., NaHCO₃) may be produced by the contact vessel upon interaction (e.g., contacting and/or mixing) with the input gas stream.

In some embodiments, the capture stream is discharged from the system. However, in other embodiments, the capture stream is transported to a different component of the system for further treatment (e.g., exposure to acidic species to promote release of gaseous carbon dioxide).

In some embodiments, the electrogenerated basic species and the carbon dioxide from the input gas stream are exposed to each other in a gas-liquid contact vessel. For example, in FIG. 1A, gas-liquid contact vessel 131 receives (a) input gas stream 105 comprising carbon dioxide and (b) contact vessel liquid inlet stream 106, which comprises at least a portion of base-rich product solution stream 103 comprising electrogenerated basic species, such that the basic species can interact with the carbon dioxide as described above. In some embodiments, at least a portion of the base-rich product solution is transported from the electrolysis assembly to the contact vessel by forming at least a portion of the contact vessel liquid inlet stream (e.g., via a fluidic connection between the first electrolysis assembly liquid outlet and the contact vessel liquid inlet). The input gas stream may be transported to the contact vessel via the contact vessel gas inlet. In some embodiments, the gas-liquid contact vessel is separate from the electrolysis assembly (e.g., separate from the electrolytic cell). This may permit the interaction between the carbon dioxide and the electrogenerated species to occur in a location separate from the electrolysis assembly (e.g., after expulsion of basic species from the electrolysis assembly).

Any of a variety of gas-liquid contact vessels may be employed. The gas-liquid contact vessel may comprise a gas-liquid contactor configured to promote mass and in some instances heat transfer between gas-phase species and liquid-phase species. In some embodiments, the contact vessel comprises a differential gas-liquid contactor. In other embodiments, the contact vessel comprises a stepwise gas-liquid contactor. Examples of types of gas-liquid contact vessels include, but are not limited to bubble columns, spray towers, cooling towers, packed columns, agitated vessels, plate columns, rotating disc contactors, Venturi tubes, hollow fiber gas-liquid contactors. In some embodiments, the gas-liquid contact vessel comprises an interior volume in fluid communication with the gas inlet and the liquid inlet. The interior volume may permit contact between the input gas stream and the contact vessel inlet liquid stream. Contact between carbon dioxide from the input gas stream and liquid from the inlet liquid stream may result in the dissolution of at least some of the gaseous carbon dioxide. The carbon dioxide may then undergo the acid-base equilibria described above.

In some embodiments, the captured carbon dioxide (e.g., in the form of bicarbonate and/or carbonate anions) is released to form gaseous carbon dioxide. For example, in some embodiments, at least some of the dissolved carbonate ions and/or dissolved bicarbonate anions in (or from) the capture stream are exposed to at least some of the electrogenerated acidic species. The acidic species may cause a drop in pH and drive acid-base equilibria in the opposite direction as during the capture process described above, protonating carbonate and/or bicarbonate to form carbonic acid, which converts to dissolved carbon dioxide, which may leave the resulting solution as gaseous carbon dioxide (e.g., via desorption).

As such, in some embodiments, the exposure of the acidic species formed directly or indirectly from the electrical potential difference-induced reactions in the electrolysis assembly to the dissolved bicarbonate and/or bicarbonate anions in the capture stream may generate a carbon dioxide-rich output gas stream and a release stream.

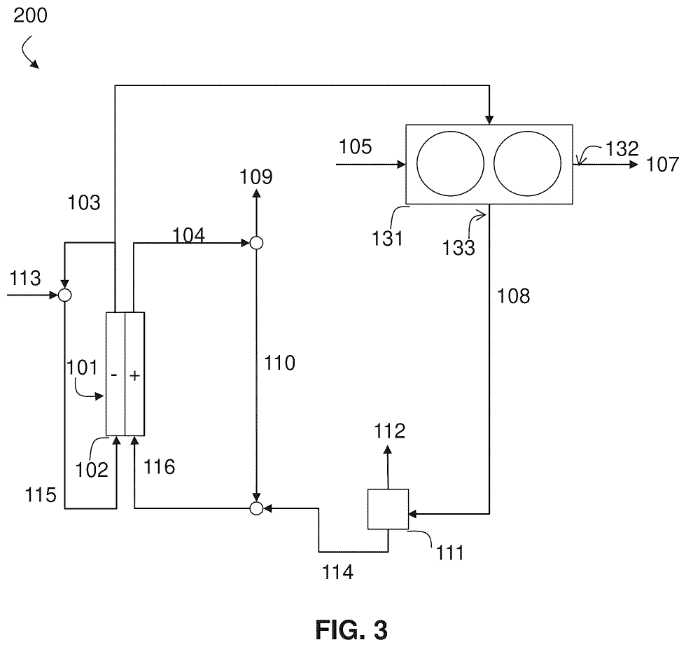

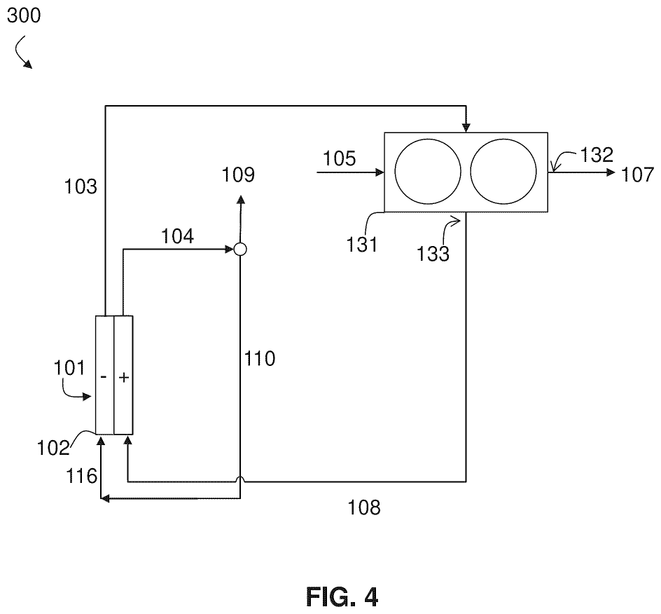

As noted above, the interaction between the acidic species and the dissolved bicarbonate and/or carbonate anions in (or from) the capture stream (e.g., via one or more acid-base equilibrium reactions) may produce a carbon dioxide-rich output gas stream. For example, in FIG. 1A, carbon dioxide-rich output gas stream 109 may be generated upon combination of at least a portion of capture stream 108 and at least a portion of acid-rich product solution 104. While FIG. 1A shows this combination of acidic species and the capture stream occurring external to the electrolysis assembly, in other embodiments, the acid-rich product solution may be exposed to the bicarbonate and/or carbonate ions within the electrolysis assembly, such as within the anolyte chamber itself. FIGS. 3-4 show non-limiting such example embodiments, described in more detail below.

The carbon dioxide-rich gas outlet stream may have a relatively high concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the carbon dioxide-rich gas outlet stream comprises carbon dioxide in an amount of greater than or equal to 100,000 ppm, greater than or equal to 200,000 ppm, greater than or equal to 500,000 ppm, and/or up to 600,000 ppm, up to 700,000 ppm, up to 800,000 ppm, up to 900,000 ppm, up to 950,000 ppm, up to 980,000 ppm, up to 990,000 ppm, up to 999,000 ppm or more (e.g., pure carbon dioxide gas) by volume. Combinations of these ranges are possible.

The carbon dioxide-rich output gas stream may have a higher concentration of carbon dioxide than the input gas stream. For example, in some embodiments, a molar ratio of the concentration of carbon dioxide in the carbon dioxide-rich output gas stream to the concentration of carbon dioxide in the input gas stream is at least 2, at least 2.5, at least 5, at least 10, at least 50, at least 100, at least 1000, at least 10,000, at least 100,000, and/or up to 1,000,000, up to 10,000,000, up to 100,000,000, or more. Combinations of these ranges are possible.

The carbon dioxide-rich output gas stream may comprise moisture. For example, in some embodiments, the carbon dioxide-rich output gas stream has a moisture content of greater than or equal to 0.001%, greater than or equal to 0.01%, greater than or equal to 0.1%, and/or up to 0.5%, up to 1% or more by weight.

In some embodiments, at least a portion (e.g., at least 10 mol %, at least 25 mol %, at least 50 mol %, at least 75 mol %, at least 90 mol %, at least 95 mol %, at least 98 mol %, at least 99 mol %, or more) of the carbon dioxide-rich output gas stream is discharged from the system. The discharged carbon dioxide-rich stream may be used to, for example, sequester the carbon dioxide and/or to employ the carbon dioxide as a reagent for further processing (e.g., to generate fuels, plastics, commodity chemicals, and/or specialty chemicals). However, in some embodiments, at least a portion of the carbon dioxide-rich output gas stream is transferred to one or more other components of the system (e.g., for further processing).

In addition to the carbon dioxide-rich output gas stream, the interaction between the acidic species and the dissolved carbonate and/or bicarbonate anions in the capture stream may produce a release stream. For example, in FIG. 1A, release stream 110 may be produced upon mixture of at least a portion of acid-rich product solution 104 and at least a portion of capture stream 108. The release stream may comprise an aqueous solution of dissolved ions. For example, in some embodiments, the release stream comprises at least some of the dissolved cations and at least some of the anions (e.g., originally from the aqueous input stream). For example, the acid-rich product solution may comprise dissolved HCl (thereby comprising dissolved chloride ions), while the capture stream may comprise dissolved Na₂CO₃ (thereby comprising dissolved sodium ions). Upon release of CO₂ gas (e.g., in the carbon dioxide-rich output gas stream), the resulting release stream may comprise dissolved NaCl (thereby comprising dissolved sodium ions and dissolved chloride ions).

The cations may be present in the release stream in a relatively high concentration. In some embodiments, the dissolved cations are present in the release stream at a concentration of greater than or equal to 0.05 M, greater than or equal to 0.1 M, greater than or equal to 0.2 M, greater than or equal to 0.5 M, greater than or equal to 1 M, greater than or equal to 1.5 M, up to 2 M, up to 3 M, up to 5 M, up to 10 M, or greater. Combinations of these ranges (e.g., greater than or equal to 0.05 M and less than or equal to 10 M, greater than or equal to 0.5 M and less than or equal to 3 M) are possible. The anions may be present in the release stream in a relatively high concentration. In some embodiments, the dissolved anions are present in the release stream at a concentration of greater than or equal to 0.05 M, greater than or equal to 0.1 M, greater than or equal to 0.2 M, greater than or equal to 0.5 M, greater than or equal to 1 M, greater than or equal to 1.5 M, up to 2 M, up to 3 M, up to 5 M, up to 10 M, or greater. Combinations of these ranges (e.g., greater than or equal to 0.05 M and less than or equal to 10 M, greater than or equal to 0.5 M and less than or equal to 3 M) are possible.

Due to the release of the captured carbon dioxide, the release stream may comprise bicarbonate anions and/or carbonate anions in a lower concentration than in the capture stream. For example, in some embodiments, the molar ratio of the concentration of bicarbonate anions and/or carbonate anions in the capture stream to the concentration of bicarbonate anions and/or carbonate anions in the release stream is at least 1.005, at least 1.01, at least 1.05, at least 1.1, at least 1.2, at least 1.5, at least 2, at least 5, at least 10, at least 50, at least 100, at least 1,000, at least 10,000, at least 100,000, at least 1,000,000, at least 10,000,000, and/or up to 100,000,000, up to 1,000,000,000, or more. Combinations of these ranges (e.g., greater than or equal to 1.005 and less than or equal to 1,000,000,000, greater than or equal to 2 and less than or equal to 1,000,000) are possible. In some embodiments, the release stream is free of bicarbonate and/or carbonate anions.

In some embodiments, at least a portion of the release stream is discharged from the system. In some embodiments, at least a portion of the release stream undergoes one or more additional processing steps. For example, in some embodiments, at least a portion of the release stream is concentrated with respect to the dissolved cations and/or the dissolved anions. In some embodiments, the concentration of the dissolved cations and dissolved anions in the release stream is increased, thereby forming a concentrated release stream. Concentration of the release stream may permit for at least a portion of the concentrated release stream to be usable as an input elsewhere in the system, such as for the electrolysis assembly (e.g., as part of or all of the aqueous input stream). For example, in FIG. 1B, at least a portion of release stream 110 is transported to concentrator 111 via concentrator liquid inlet 134. The concentration of the ions may be increased by removing water from the release stream. For example, the concentrator (e.g., concentrator 111) may be configured to remove water from the liquid received by the concentrator liquid inlet.

Any of a variety of concentrators may be employed. The concentrator may comprise a concentrator liquid inlet configured to receive a liquid comprising a solute and a concentrated stream outlet configured to output a liquid comprising the solute at a higher concentration of the solute. For example, the concentrator may be configured to mechanically, chemically, and/or thermally separate water from the liquid. Examples of concentrators include, but are not limited to, reverse osmosis units (e.g., standard reverse osmosis units and/or osmotically assisted reverse osmosis units), nanofiltration units, thermal concentrators (e.g., evaporators), humidification units, and/or combinations thereof (e.g., a combination of a reverse osmosis unit and a thermal concentrator). Another non-limiting example of a concentrator is a forward osmosis unit. Non-limiting examples of evaporators include multiple-effect evaporators, distillation units (e.g., multi-stage flash distillation), and mechanical vapor compression evaporators.

In some embodiments, the concentrator liquid inlet is fluidically connected to the second electrolysis assembly liquid outlet. For example, in FIG. 1B, concentrator liquid inlet 134 is fluidically connected to second electrolysis assembly liquid outlet 135. In some embodiments, the concentrator liquid inlet is fluidically connected to the contact vessel liquid outlet. For example, in FIG. 1B, concentrator liquid inlet 134 is fluidically connected to contact vessel liquid outlet 133. This connectivity may permit at least a portion of the combination of the capture stream and the acid-rich product solution, which may be in the form of the release stream, to be transported to the concentrator.

In some embodiments, the concentrator comprises a concentrated stream outlet. A concentrated release stream (e.g., formed by removal of at least some water) may be output from the concentrator via the concentrated stream outlet. For example, in FIG. 1B, concentrated release stream 140 may be output via concentrated stream outlet 136. The concentration of the dissolved cations and/or dissolved ions in the concentrated release stream may be greater than those in the release stream by a factor of at least 1.05, at least 1.1, at least 1.2, at least, 1.5, at least 2, at least 5, at least 10, and/or up to 20, up to 50, or more. Combinations of these ranges are possible.

In some embodiments, the concentrator comprises a diluted stream outlet configured to output at least a portion of water removed from the liquid received by the concentrator inlet. The diluted stream may comprise pure water or water with a relatively low concentration of other species.

In some embodiments, at least a portion of the base-rich product solution is combined with a dilution stream, thereby forming a diluted base-rich product solution. The dilution stream may comprise at least a portion of water removed from the release stream during formation of the concentrated release stream. FIG. 1B shows one such embodiment, where diluted stream outlet 137 is fluidically connected to contact vessel liquid inlet 138 such that at least a portion of diluted stream 112 can be combined with at least a portion of base-rich product solution 103. As also shown in FIG. 1B, diluted stream outlet 137 may be fluidically connected to first electrolysis assembly outlet 142 of electrolysis assembly 101. This configuration may permit, for example, combination of base-rich product solution 103 exiting first electrolysis assembly outlet 142 and diluted stream 112 to form some or all of contact vessel liquid inlet stream 106. The diluted base-rich product solution may have a lower concentration of the basic species than the non-diluted base-rich product solution (e.g., by a factor of at least 1.5, at least 2, at least 5, and/or up to 10, or more). Such a process may permit the reuse of water removed from the concentration step and/or balance the concentrations of inputs in, for example, the contact vessel.

In some embodiments, at least a portion of the diluted base-rich product solution is used as part or all of the contact vessel liquid inlet stream. In some embodiments, at least a portion of the diluted base-rich product solution is recycled back to the electrolysis assembly, as discussed below.

In some embodiments, one or more streams produced in the system are recycled to another component of the system. For example, in some embodiments, the aqueous input stream comprises at least a portion (e.g., at least 0.5 wt %, at least 1 wt %, at least 2 wt %, at least 5 wt %, at least 10 wt %, at least 25 wt %, at least 50 wt %, at least 75 wt %, at least 90 wt %, at least 95 wt %, at least 98 wt %, at least 99 wt %, at least 99.9 wt %, or all) of the release stream. In some embodiments, the aqueous input stream comprises at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the solute (e.g., dissolved cations and dissolved anions) of the release stream.

In some embodiments in which the release stream is concentrated (e.g., via the concentrator), the aqueous input stream comprises at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the concentrated release stream. For example, the aqueous input stream may comprise at least 90 wt % and up to 100 wt % of the concentrated release stream. This may be achieved, for example, by having the concentrated stream outlet of the concentrator be fluidically connected to the one or more electrolysis assembly liquid inlets. For example, in FIG. 1B, concentrated stream outlet 136 of concentrator 111 is fluidically connected to electrolysis assembly liquid inlet 139. It has been realized in the context of this disclosure that concentrating at least a portion the release stream for recycling back into the electrolysis assembly can, in some instances, lowers costs by permitting full (or nearly full) salt recycling (which may reduce or obviate the need for expensive salt operating costs) and/or by maintaining high conductivity in the cell using relatively concentrated electrolyte feed solutions as aqueous input streams.

In some embodiments, one or more electrolysis assembly liquid inlets are fluidically connected to the second electrolysis assembly liquid outlet and the contact vessel liquid outlet. For example, FIG. 1B shows electrolysis assembly liquid inlet 139 as being fluidically connected to second electrolysis assembly liquid outlet 135 and contact vessel liquid outlet 133 (with the fluidic connections in FIG. 1B being indirect fluidic connections).

In some embodiments, the aqueous input stream is a first aqueous input stream and comprises at least a portion of the release stream and at least a portion of the capture stream. This may be accomplished, for example, by having the anolyte chamber of the electrolytic cell comprise an inlet fluidically connected to the second electrolysis assembly liquid outlet and the contact vessel liquid outlet. For example, in FIG. 3, first aqueous input stream 116 (comprising the cations and anions as discussed above) is transported to an inlet of an anolyte chamber of electrolytic cell 102 of system 200, with first aqueous input stream 116 comprising at least a portion of release stream 110 and at least portion of capture stream 108 (e.g., which in FIG. 3 is shown as being concentrated by concentrator 111 to form concentrated capture stream 114 such that first aqueous input stream comprises at least a portion of concentrated capture stream 114). In some such embodiments, the electrolytic cell has the configuration shown in FIG. 2B. By combining the capture stream (e.g., the concentrated capture stream) and the release stream, the anolyte chamber may receive an aqueous input stream comprising a relatively high concentration of the cations (e.g., sodium ions), anions (e.g., halide ions such as chloride ions), and bicarbonate and/or carbonate anions. In some such instances, electrogeneration of acidic species in the anolyte chamber results in generation of carbon dioxide from bicarbonate and/or carbonate anions within the anolyte chamber. Accordingly, in FIG. 3, for example, acid-rich product solution 104 may include acidic species, carbon dioxide (which can be flashed off as carbon dioxide-rich output gas stream 109), and dissolved salt (e.g., dissolved sodium chloride or dissolved potassium dihydrogen phosphate).

In some embodiments, a second aqueous input stream is transported to the catholyte chamber, the second aqueous input stream comprising at least a portion of the diluted base-rich product solution. This may be accomplished, for example, by the catholyte chamber comprising an inlet fluidically connected to the first electrolysis assembly liquid outlet. For example, referring again to FIG. 3, diluted base-rich product stream 115 is produced by combining a portion of base-rich product solution 103 and dilution stream 113 (e.g., pure water). Diluted base-rich product stream 115 may be transported to an inlet of the catholyte chamber of electrolytic cell 102 as a second aqueous input stream.

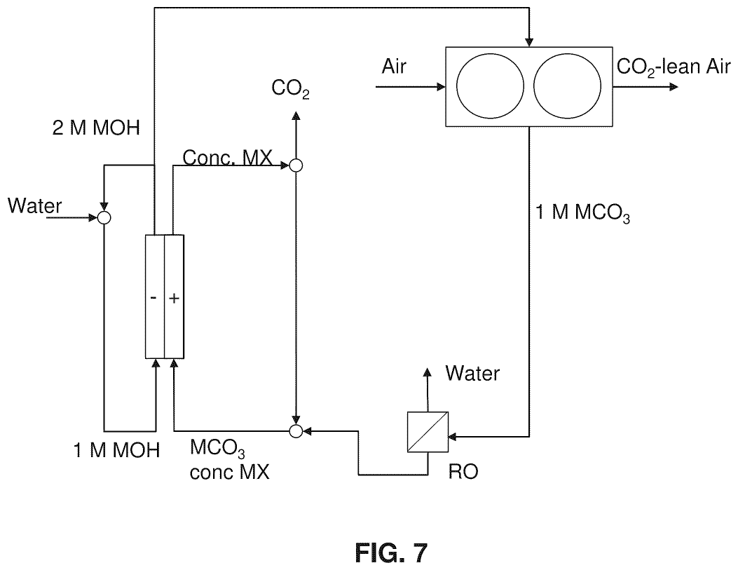

FIG. 7 shows a non-limiting, illustrative example of the embodiment shown in FIG. 3. In FIG. 7, an aqueous input stream of MCO₃ (e.g., Na₂CO₃) and concentrated MX (e.g., NaCl) is transported to the anolyte chamber, while a 1 M solution of MOH (e.g., NaOH) is transported to the catholyte chamber. Electrolysis (e.g., to perform the hydrogen oxidation reaction in the anolyte chamber and the hydrogen evolution reaction in the catholyte chamber) produces a base-rich product solution of 2 M MOH and an acid-rich product solution that generates concentrated MX (e.g., NaCl) and dissolved carbon dioxide, which can be flashed off as a carbon dioxide-rich gas stream (CO₂). The 2 M MOH stream can be transported to the gas-liquid contactor where it is combined with air to form a CO₂-lean air stream and a 1 M MCO₃ aqueous stream (as a capture stream). The 1 M MCO₃ aqueous stream is concentrated by a reverse osmosis unit to generate water (e.g., as a permeate) and a concentrated MCO₃ aqueous stream (a concentrated capture stream), which is finally combined with the resulting concentrated MX stream (after CO₂ flashing) to reform the aqueous input stream fed to the anolyte chamber. Additionally, a portion of the 2 MOH base-rich product stream is diluted with water to reform the 1 MOH stream that is transported to the catholyte chamber.

In some embodiments, the aqueous input stream is a first aqueous input stream and comprises at least a portion of the release stream. This may be accomplished, for example, by having the catholyte chamber of the electrolytic cell comprise an inlet fluidically connected to the second electrolysis assembly liquid outlet. For example, in FIG. 4, first aqueous input stream 116 (comprising the cations and anions as discussed above) is transported to an inlet of a catholyte chamber of electrolytic cell 102 of system 300, with first aqueous input stream 116 comprising at least a portion of release stream 110. In some such embodiments, the electrolytic cell has the configuration shown in FIG. 2A. By recycling the release stream, the catholyte chamber may receive an aqueous input stream comprising a relatively high concentration of the cations (e.g., sodium ions) and anions (e.g., halide ions such as chloride ions).

In some such embodiments, a second aqueous input stream is transported to the anolyte chamber, the second aqueous input stream comprising at least a portion of the capture stream. This may be accomplished, for example, by the anolyte chamber comprising an inlet fluidically connected to the contact vessel liquid outlet. For example, referring again to FIG. 4, capture stream 108 may be transported from contact vessel liquid outlet 133 to an inlet of the anolyte chamber of electrolytic cell 102 as a second aqueous input stream.

In some such instances, electrogeneration of acidic species in the anolyte chamber may result in the generation of carbon dioxide from dissolved bicarbonate and/or carbonate anions within the anolyte chamber. Accordingly, in FIG. 4, for example, acid-rich product solution 104 may include both acidic species, carbon dioxide (which can be flashed off as carbon dioxide-rich output gas stream 109), and dissolved salt (e.g., dissolved sodium chloride).

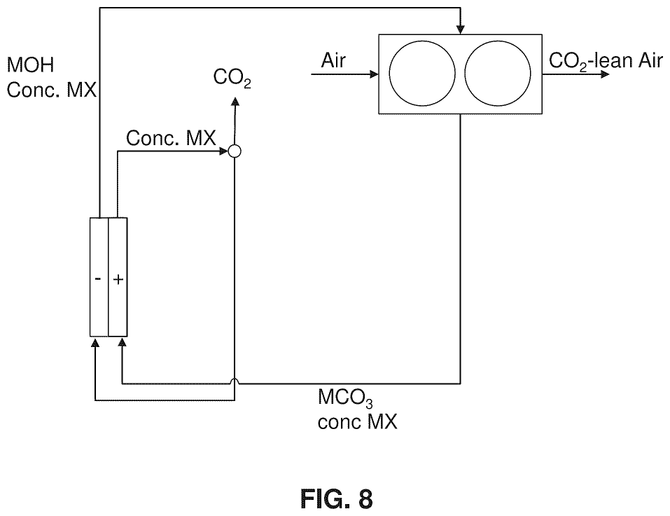

FIG. 8 shows a non-limiting, illustrative example of the embodiment shown in FIG. 4. In FIG. 8, a first aqueous input stream of concentrated MX (e.g., NaCl) is transported to the catholyte chamber, while a second aqueous stream of MCO₃ (e.g., Na₂CO₃) and concentrated MX is transported to the anolyte chamber. Electrolysis (e.g., to perform the hydrogen oxidation reaction in the anolyte chamber and the hydrogen evolution reaction in the catholyte chamber) produces a base-rich product solution of MOH (e.g., NaOH) and concentrated MX and an acid-rich product solution. The acid-rich production solution generates concentrated MX and dissolved carbon dioxide, which can be flashed off as a carbon dioxide-rich gas stream (CO₂) to form a concentrated MX stream (as a release stream). The resulting concentrated MX stream is recirculated back to reform the first aqueous input stream fed to the catholyte chamber. The MOH/concentrated MX stream can be transported to the gas-liquid contactor where it is combined with air to form a CO₂-lean air stream and an aqueous stream of MCO₃ and concentrated MX (as a capture stream), which is recirculated back to reform the second aqueous stream fed to the anolyte chamber.

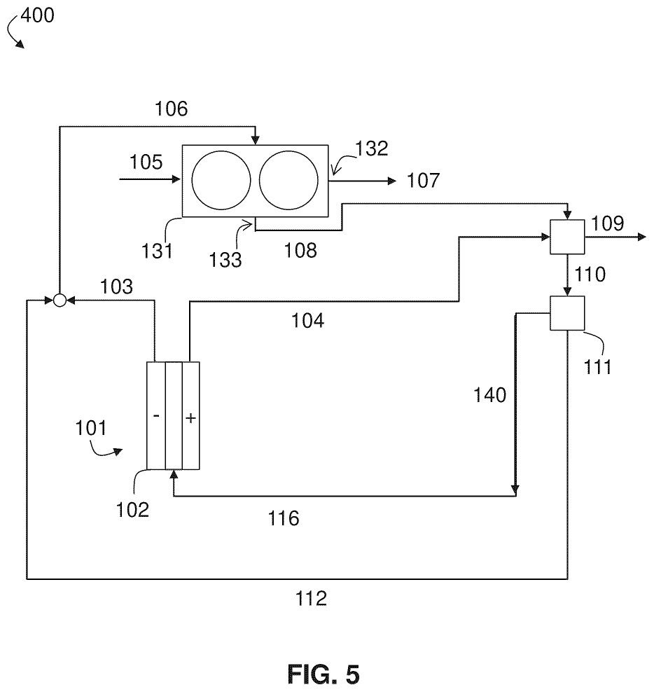

In some embodiments, the aqueous input stream is transported to the electrolyte chamber of the electrolytic cell (e.g., separated from the catholyte chamber and the anolyte chamber by cation-selective and anion-selective membranes, respectively). The aqueous input stream may comprise at least a portion of the concentrated release stream. For example, in FIG. 5, aqueous input stream 116 (comprising the cations and anions as discussed above) is transported to an inlet of a central electrolyte chamber of electrolytic cell 102 of system 400, with aqueous input stream 116 comprising at least a portion of concentrated release stream 140, which in FIG. 5 is shown as being concentrated by concentrator 111. In some such embodiments, the electrolytic cell has the configuration shown in FIG. 2C.

In some embodiments, a diluted stream produced by the concentrator (e.g., comprising pure water) is combined with at least a portion of the base-rich product solution, as discussed above. For example, in FIG. 5, diluted stream 112 output by concentrator 111 is combined with base-rich product solution 103 to form at least part of contact vessel liquid inlet stream 106. This may be accomplished, for example, by the contact vessel liquid inlet being fluidically connected to the first electrolysis assembly outlet and the concentrator diluted stream outlet.

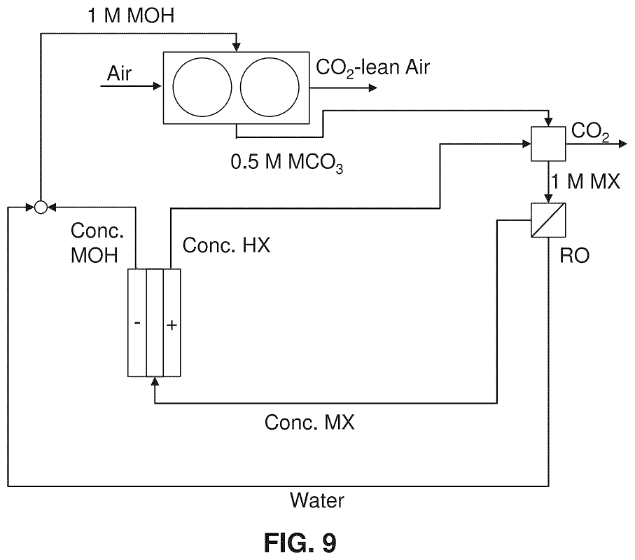

FIG. 9 shows a non-limiting, illustrative example of the embodiment shown in FIG. 5. In FIG. 9, an aqueous input stream of concentrated MX (e.g., NaCl) is transported to the central electrolyte chamber of the electrolytic cell. Electrolysis (e.g., to perform the hydrogen oxidation reaction in the anolyte chamber and the hydrogen evolution reaction in the catholyte chamber) produces a base-rich product solution of concentrated MOH (e.g., NaOH) and an acid-rich product solution of concentrated HX (e.g., HCl). The concentrated MOH stream can be diluted with water and then transported to the gas-liquid contactor where it is combined with air to form a CO₂-lean air stream and a 0.5 M MCO₃ aqueous stream (as a capture stream). The 0.5 M MCO₃ aqueous stream is combined with the concentrated HX stream to release CO₂ and form a 1 M MX stream as a release stream. The 1 M MX stream may then be concentrated by a concentrator (e.g., a reverse osmosis unit), thereby forming a concentrated MX aqueous stream that can be recirculated back form some or all of the original aqueous input stream fed to the electrolyte chamber. Additionally, water produced by the concentrator may be used as the water that dilutes the concentrated MOH base-rich product solution described earlier.

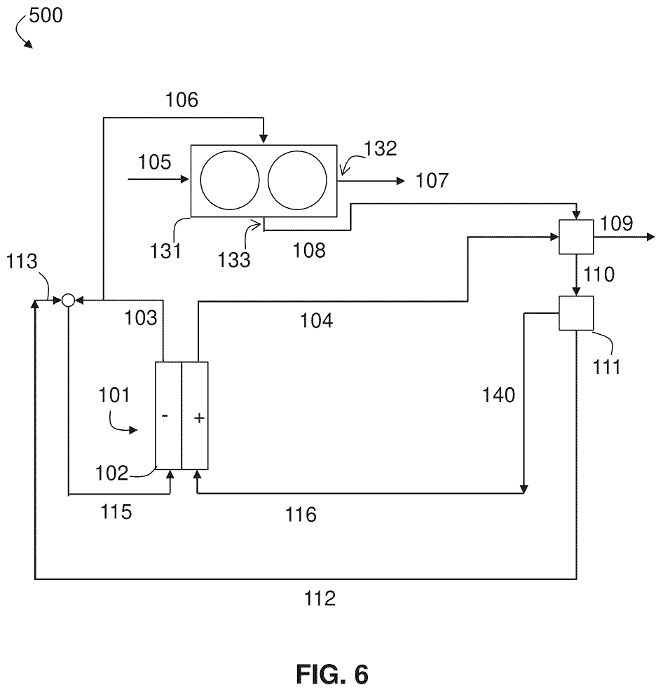

In some embodiments, the aqueous input stream is a first aqueous input stream and comprises at least a portion of the concentrated release stream. For example, in FIG. 6, first aqueous input stream 116 (comprising the cations and anions as discussed above) is transported to an inlet of an anolyte chamber of electrolytic cell 102 of system 500, with first aqueous input stream 116 comprising at least a portion of concentrated release stream 140, which in FIG. 6 is shown as being concentrated by concentrator 111. In some such embodiments, the electrolytic cell has the configuration shown in FIG. 2B.

In some embodiments, a diluted stream produced by the concentrator (e.g., comprising pure water) is combined with a portion of the base-rich product solution, as discussed above. For example, in FIG. 6, diluted stream 112 output by concentrator 111 forms at least a portion of dilution stream 113, which is combined with base-rich product solution 103 to form at least part of diluted base-rich product stream 115.

In some embodiments, a second aqueous input stream is transported to the catholyte chamber, and the second aqueous input stream comprises at least a portion of the diluted base-rich product solution. This may be accomplished, for example, by the catholyte chamber comprising an inlet fluidically connected to the first electrolysis assembly liquid outlet. For example, referring again to FIG. 6, diluted base-rich product stream 115 is produced by combining a portion of base-rich product solution 103 and dilution stream 113 (e.g., pure water). Diluted base-rich product stream 115 may be transported to an inlet of the catholyte chamber of electrolytic cell 102 as a second aqueous input stream.

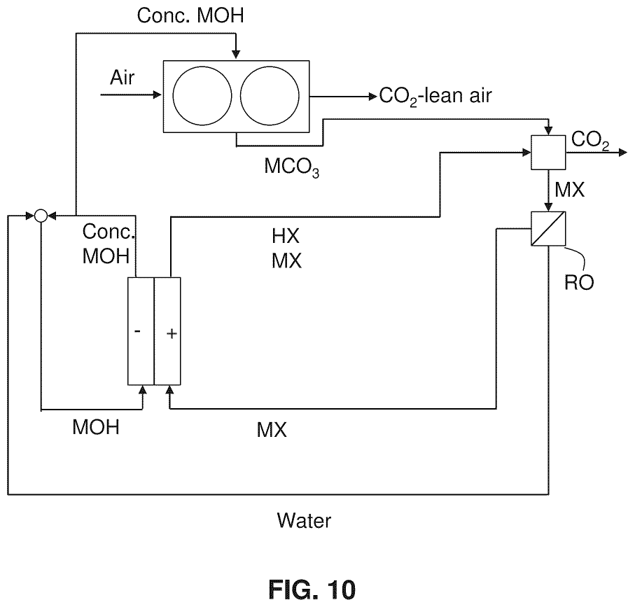

FIG. 10 shows a non-limiting, illustrative example of the embodiment shown in FIG. 6. In FIG. 10, a first aqueous input stream of concentrated MX (e.g., an alkali dihydrogen phosphate salt such as NaH₂PO₄) is transported to the anolyte chamber of the electrolytic cell, while a <1 M solution of MOH (e.g., NaOH) is transported as a second aqueous input solution to the catholyte chamber. Electrolysis (e.g., to perform the hydrogen oxidation reaction in the anolyte chamber and the hydrogen evolution reaction in the catholyte chamber) produces a base-rich product solution of concentrated MOH (e.g., NaOH) and an acid-rich product solution of concentrated HX (e.g., H₃PO₄), optionally further containing MX. The concentrated MOH stream can be transported to the gas-liquid contactor where it is combined with air to form a CO₂-lean air stream and a 0.5 M MCO₃ aqueous stream (as a capture stream). The 0.5 M MCO₃ aqueous stream is combined with the HX stream to release CO₂ and form a 1 M MX stream as a release stream. The 1 M MX stream may then be concentrated by a concentrator (e.g., a reverse osmosis unit), thereby forming a concentrated MX aqueous stream that can be recirculated back to form some or all of the first aqueous input stream fed to the anolyte chamber. Additionally, water produced by the concentrator may be used to dilute a portion concentrated MOH base-rich product solution described earlier, with the diluted base-rich product solution forming some or all of the second aqueous input stream fed to the catholyte chamber.

As noted above, in some embodiments, an aqueous input stream is transported to the electrolytic cell, where the aqueous input stream comprises dissolved alkali metal cations and dissolved non-hydroxide anions (e.g., halides, sulfate, a phosphate). In some embodiments, the alkali metal cations comprise sodium cations and/or potassium cations. In some embodiments, the aqueous input stream comprises a dissolved alkali halide salt (e.g., a dissolved alkali chloride such as NaCl and/or KCl). In some embodiments, the aqueous input stream comprises dissolved alkali metal sulfate (e.g., sodium sulfate and/or potassium sulfate). The dissolved salt of an alkali metal cation and a non-hydroxide anion may be derived from a solid mineral source of alkali metal. In some, but not necessarily all embodiments, at least 1 mol %, at least 2 mol %, at least 5 mol %, at least 10 mol %, at least 25 mol %, at least 50 mol %, at least 75 mol %, at least 95 mol %, at least 98 mol %, at least 99 mol %) or all of the cations in the aqueous input stream are alkali metal cations.

The aqueous input stream in some instances is prepared by dissolving a solid alkali metal salt comprising the alkali metal cations and non-hydroxide anions to form at least a portion of the aqueous input stream. In some such embodiments, the solid salt comprises an alkali halide such as sodium chloride (NaCl) and/or potassium chloride (KCl).

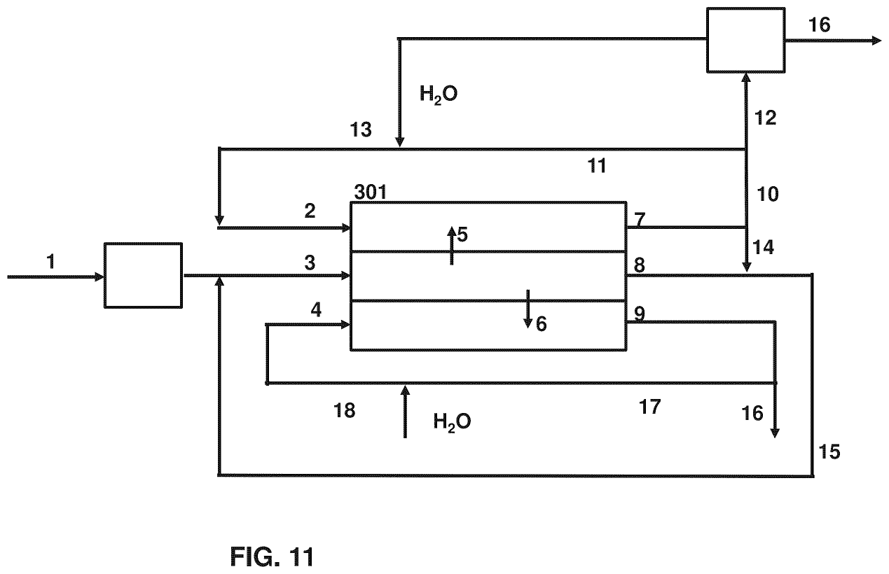

FIG. 11 shows an example of an embodiment where aqueous input stream 3 comprising alkali metal cations and non-hydroxide anions, sourced from an aqueous alkali metal source stream 1, is fed to the electrolyte chamber (middle chamber) of electrolytic cell 301. Alkali metal cations 5 are transported through a cation exchange membrane to a catholyte chamber where basic species such as hydroxide anions are electrogenerated, thereby forming stream 7 comprising a base-rich product solution comprising at least some of the alkali metal cations and at least some of the basic species (e.g., a dissolved alkali hydroxide). In some embodiments, an anolyte product solution is produced upon application of an electrical potential difference across the electrolytic cell. For example, meanwhile in FIG. 11, non-hydroxide anions 6 are transported through an anion exchange membrane from the electrolyte (middle) chamber to the anolyte chamber where product species such as but not limited to acidic species (e.g., hydronium ions and/or weak acids) are electrogenerated (e.g., via hydrogen oxidation at a hydrogen depolarization anode and/or via the oxygen evolution reaction), thereby forming stream 9 comprising an anolyte product solution (e.g., comprising an acid-rich product solution). In some embodiments, the anolyte product solution comprises at least some of the non-hydroxide anions and/or conjugate acids of at least some of the non-hydroxide anions (e.g., formed via protonation of the non-hydroxide anions caused by the anode electrolysis half-reaction performed in the anolyte chamber). In some embodiments, the anolyte product solution comprises at least some conjugate acids of at least some of the non-hydroxide anions. In some embodiments, the anolyte product solution comprises at least some of the non-hydroxide anions. For example, in FIG. 11, non-hydroxide anions 6 are transported through an anion exchange membrane from the electrolyte (middle) chamber to the anolyte chamber where product species such as but not limited to acidic species (e.g., hydronium ions) are electrogenerated (e.g., via hydrogen oxidation at a hydrogen depolarization anode), thereby forming stream 9 comprising an anolyte product solution (e.g., comprising an acid-rich product solution) comprising at least some of the non-hydroxide anions. In some such embodiments, the anolyte product solution comprises electrogenerated acidic species (e.g., the dissolved conjugate acid of the non-hydroxide anion, such as hydrochloric acid and/or sulfuric acid). Output stream 8 exits the electrolyte (middle) chamber and is free of the alkali metal cations or comprises the alkali cations at a concentration that is lower than the concentration of alkali cations in aqueous input stream 3.

In some embodiments, the anolyte product solution has a lower pH than the aqueous input stream (e.g., by at least 0.1 pH units, at least 0.2 pH units, at least 0.5 pH units, at least 1 pH unit, at least 1.5 pH units, at least 2 pH units, at least 3 pH units, at least 4 pH units, at least 5 pH units, at least 6 pH units, at least 7 pH units, at least 8 pH units, at least 9 pH units, at least 10 pH units, at least 11 pH units, at least 12 pH units, at least 13 pH units, and/or up to 14 pH units, or more). In some embodiments, such as some of in which the aqueous input stream comprising the cations and non-hydroxide anions and the anolyte input stream are different, the anolyte product solution has a lower pH than the anolyte input stream (e.g., by at least 0.1 pH units, at least 0.2 pH units, at least 0.5 pH units, at least 1 pH unit, at least 1.5 pH units, at least 2 pH units, at least 3 pH units, at least 4 pH units, at least 5 pH units, at least 6 pH units, at least 7 pH units, at least 8 pH units, at least 9 pH units, at least 10 pH units, at least 11 pH units, at least 12 pH units, at least 13 pH units, and/or up to 14 pH units, or more).

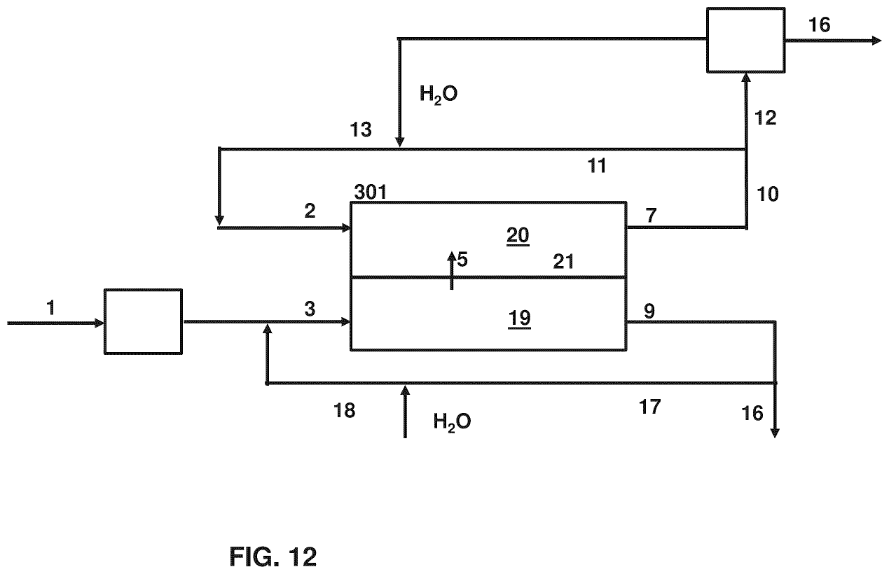

In some, but not necessarily all embodiments, two or more of the compartments of the electrolytic cell receive an aqueous input stream. For example, the catholyte chamber may receive a catholyte input stream, the anolyte chamber may receive an anolyte input stream, and/or the electrolyte (middle) chamber may receive an electrolyte input stream. In some embodiments, the catholyte input stream comprises at least a portion of the base-rich product solution. For example, referring back to FIG. 11, stream 7 comprising base-rich product solution may be split into stream 10 and stream 14, with stream 10 being further split into stream 11 and stream 12. Catholyte input stream 2 may comprise at least a portion of stream 11, which may in some instances be diluted with a dilution stream (e.g., water) to form diluted base-rich product stream 13 having a lower concentration of the electrogenerated basic species (and/or other solute) than in stream 11. In such a way, this recirculation of at least a portion of the base-rich product solution may result in the catholyte chamber of electrolytic cell 301 being fed with a catholyte input solution comprising dissolved alkali metal cations and dissolved basic species (e.g., dissolved alkali hydroxide such as NaOH and/or KOH). Of course, it should be understood that this recirculation is optional and in some embodiments no such recirculation is performed. FIGS. 3 and 6 also show examples of embodiments different than that in FIG. 11 in which an aqueous input stream comprises at least a portion of a diluted base-rich product solution. The two-chamber electrolytic cell embodiment in FIG. 12 described below is also an example other than that in FIG. 11 in which an aqueous input stream comprises at least a portion of a base-rich product solution (e.g., in some embodiments at least a portion of a diluted base-rich product solution).

Stream 12 in FIG. 11 comprising alkali cations and basic species may be concentrated (e.g., via any of a variety of known techniques), thereby producing a concentrated aqueous solution of the alkali metal cations and basic species (e.g., concentrated alkali hydroxide). The concentrated aqueous solution may then be discharged from the system, and/or dried to form solid alkali metal-containing material.

As noted above, in some embodiments, the electrolytic cell of the system that receives the aqueous input stream may be a two-chamber electrolytic cell. FIG. 12 shows an example of an embodiment that is similar in operation to the embodiment in FIG. 11, but where aqueous input stream 3 comprising alkali metal cations and non-hydroxide anions, sourced from an aqueous alkali metal source stream 1, is fed to anolyte chamber 19 of electrolytic cell 301. The anolyte chamber and catholyte chamber may be separated by an ion-selective membrane such as a cation-selective membrane, which may in some embodiments be the sole ion-selective membrane in the cell. For example, in some embodiments, alkali metal cations 5 are transported through cation exchange membrane 21 to catholyte chamber 20 where basic species such as hydroxide anions are electrogenerated, thereby forming stream 7 comprising a base-rich product solution comprising at least some of the alkali metal cations and at least some of the basic species (e.g., a dissolved alkali hydroxide). As described above, in some embodiments, an anolyte product solution is produced upon application of an electrical potential difference across the electrolytic cell. For example, meanwhile in FIG. 12, non-hydroxide anions are supplied to the anolyte chamber via aqueous input stream 3. In the anolyte chamber, product species such as but not limited to acidic species (e.g., hydronium ions and/or weak acids) are electrogenerated (e.g., via hydrogen oxidation at a hydrogen depolarization anode and/or via the oxygen evolution reaction), thereby forming stream 9 comprising an anolyte product solution (e.g., comprising an acid-rich product solution). As noted above, in some embodiments, the anolyte product solution comprises at least some of the non-hydroxide anions and/or conjugate acids of at least some of the non-hydroxide anions (e.g., formed via protonation of the non-hydroxide anions caused by the anode electrolysis half-reaction performed in the anolyte chamber). It has been observed in the context of this disclosure that certain chemistries, including some involving use of weak acids as the acidic species and/or conjugate bases of weak acids as the non-hydroxide anions, may permit beneficially high Faradaic efficiencies for the electrochemical processes described above, which may be advantageous when employing, for example a two-compartment electrolytic cell (e.g., with a cation-selective membrane separating the catholyte and anolyte chambers).

In some embodiments, one or more input stream of the electrolytic cell (e.g., the anolyte input stream) comprises at least a portion of the anolyte product solution (e.g., at least a portion of an acid-rich product solution). For example, in some embodiments, the stream fed to the anolyte chamber of the electrolytic cell comprises at least a portion of the anolyte product solution (e.g., at least a portion of an acid-rich product solution). The stream fed to the anolyte chamber may be the aqueous input stream (e.g., comprising alkali metal cations and non-hydroxide anions) in some embodiments (e.g., employing a two-chamber electrolytic cell). The embodiment shown in FIG. 12 is one such embodiment. In such a case the aqueous input stream comprising the cations (e.g., alkali metal cations) and the non-hydroxide anions is the same as the anolyte input stream. However, in some embodiments, the stream fed to the anolyte chamber is the anolyte input stream, and the aqueous input stream (e.g., comprising alkali metal cations and non-hydroxide anions) is fed to a different chamber of the electrolytic cell. For example in some such embodiments, the aqueous input stream (e.g., comprising alkali metal cations and non-hydroxide anions) is fed to an electrolyte chamber (middle chamber) of a three-chamber electrolytic cell). As such, in some embodiments, at least a portion of the anolyte product stream (e.g., at least a portion of the acid-rich product solution) is recirculated back to the electrolytic cell. For example, referring back to FIG. 11, stream 9 comprising anolyte product solution (e.g., acid-rich product solution) may be split into stream 16 (which is discharged from the system) and stream 17. Anolyte input stream 4 may comprise at least a portion of stream 17, which may in some instances be diluted with a dilution stream (e.g., water) to form a diluted anolyte product solution in the form of diluted anolyte product stream 18 (e.g., diluted acid-rich product stream 18) having a lower concentration of electrogenerated product species (e.g., electrogenerated acidic species (and/or other solute)) than in stream 17. As another example, as shown in FIG. 12, aqueous input stream 3 may comprise at least a portion of stream 17, which may in some instances be diluted with a dilution stream (e.g., water) to form diluted anolyte product stream 18 (e.g., diluted acid-rich product stream 18) having a lower concentration of electrogenerated product species (e.g., electrogenerated acidic species (and/or other solute)) than in stream 17. In such a way, this recirculation of at least a portion of the anolyte product stream (e.g., acid-rich product solution) may result in the anolyte chamber of electrolytic cell 301 being fed with an anolyte input stream comprising dissolved species such as dissolved acid (e.g., hydrochloric acid and/or sulfuric acid). Recirculation of such species (e.g., acid) produced by the process may reduce or eliminate the need to introduce fresh species (e.g., fresh acid), which may increase efficiency and cost-effectiveness of the system. Of course, it should be understood that this recirculation is optional and in some embodiments no such recirculation is performed.

In some embodiments, at least a portion of the anolyte product solution (e.g., an acid-rich product solution) is combined with a stream containing dissolved carbonate ions and/or dissolved bicarbonate ions. For example, referring back to FIG. 11 and FIG. 12, rather than being discharged from the system, stream 16 may be combined with a stream containing dissolved carbonate ions and/or dissolved bicarbonate ions (e.g., a capture stream as described elsewhere in this disclosure). In some embodiments, the combination of the anolyte product solution and the stream containing dissolved carbonate ions and/or dissolved bicarbonate ions generates a carbon dioxide-rich output gas stream comprising carbon dioxide. The carbon dioxide-rich output gas stream may comprise carbon dioxide at any of the concentrations described elsewhere in this disclosure for the carbon dioxide-rich output gas stream. In some embodiments, the combination of the anolyte product solution and the stream containing dissolved carbonate ions and/or dissolved bicarbonate ions generates a release stream containing at least some of the non-hydroxide anions.

As noted elsewhere, the anolyte product solution may comprise electrogenerated acidic species. The acidic species may comprise, for example, hydronium ions and/or other acidic species such as those generated by protonating the non-hydroxide anions to form, for example, weak acids. In some embodiments in which the anolyte product solution comprises electrogenerated acidic species, the concentration of the acidic species in the anolyte product solution is greater than the concentration of the acidic species in the stream fed to the anolyte chamber (e.g., the aqueous input stream or a separate anolyte input stream). In some embodiments in which the stream fed to the anolyte chamber also comprises the acidic species, a molar ratio of the concentration of the acidic species in the anolyte product solution to the concentration of the acidic species in the stream fed to the anolyte chamber is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In FIG. 11, at least a portion of stream 8, which may be free of the dissolved alkali metal cations or comprise a lower concentration of alkali metal cations (e.g., as a dilute brine solution comprising alkali metal cations and non-hydroxide anions such as an alkali chloride and/or an alkali sulfate), may be recirculated back as stream 15 to form at least some of aqueous input stream 3.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

In some embodiments, a method for obtaining an alkali metal-containing material, comprises: transporting an aqueous input stream and a catholyte input stream to an electrolytic cell, the aqueous input stream comprising alkali metal cations and non-hydroxide anions; and applying an electrical potential difference across the electrolytic cell and performing one or more reactions to produce: a base-rich product solution comprising electrogenerated basic species and at least some of the alkali metal cations; and an anolyte product solution produced by a hydrogen oxidation half-reaction in an anolyte chamber that receives at least some of the non-hydroxide anions; wherein the catholyte input stream comprises at least a portion of the base-rich product solution. In some such embodiments, the method further comprises combining at least a portion of the base-rich product solution with a dilution stream, thereby forming a diluted base-rich product solution, wherein the catholyte input stream comprises at least a portion of the diluted base-rich product solution.

In some embodiments, a method for obtaining an alkali metal-containing material, comprises: transporting an aqueous input stream to an electrolytic cell, the aqueous input stream comprising alkali metal cations and non-hydroxide anions; and applying an electrical potential difference across the electrolytic cell and performing one or more reactions to produce: a base-rich product solution comprising electrogenerated basic species and at least some of the alkali metal cations; and an anolyte product solution produced by a hydrogen oxidation half-reaction in an anolyte chamber that receives at least some of the non-hydroxide anions and is fed by the aqueous input stream or a separate anolyte input stream, wherein the anolyte product solution comprises electrogenerated acidic species, wherein a concentration of the acidic species in the anolyte product solution is greater than a concentration of the acidic species in the stream fed to the anolyte chamber; wherein the stream fed to the anolyte chamber comprises at least a portion of the anolyte product solution. In some such embodiments, the stream fed to the anolyte chamber is an anolyte input stream and the aqueous input stream is fed to a different chamber of the electrolytic cell. However, in other embodiments, the stream fed to the anolyte chamber is the aqueous input stream.

As used herein, two elements are fluidically connected to each other when they are connected such that, under at least one configuration of the elements and any intervening elements, the two elements are in fluidic communication with each other. Two components connected by a valve and conduits that permit flow between the components in at least one configuration of the valve would be said to be fluidically connected to each other. To further illustrate, two components that are connected by a valve and conduits that permit flow between the components in a first valve configuration but not a second valve configuration are considered to be fluidically connected to each other both when the valve is in the first configuration and when the valve is in the second configuration. In contrast, two components that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

U.S. Provisional Patent Application No. 63/640,075, filed Apr. 29, 2024, and entitled “Capture and Release of Carbon Dioxide Using Electrogenerated Acids and Bases,” and U.S. Provisional Patent Application No. 63/687,571, filed Aug. 27, 2024, and entitled “Capture and Release of Carbon Dioxide Using Electrogenerated Acids and Bases,” are each incorporated herein by reference in its entirety for all purposes.

The following examples are intended to illustrate certain embodiments of the present invention, but do not exemplify the full scope of the invention.

### Example 1

This Example describes operation of an electrolytic cell using aqueous input streams described in this disclosure to produce base-rich product streams and acid-rich product streams usable in various of the embodiments for capture and release of carbon dioxide discussed in this disclosure. Specifically, a three-compartment electrolytic cell was employed to treat a potassium chloride input solution sent to the anolyte chamber.

The electrolytic cell had the configuration shown in FIG. 2C, employing a platinum-coated Ni mesh cathode, a platinum/carbon gas diffusion anode, and three liquid chambers. The catholyte chamber and the middle electrolyte “brine” chamber were separated by a Nafion™ sulfonated tetrafluoroethylene based fluoropolymer-copolymer cation exchange membrane. The anolyte chamber and middle electrolyte “brine” chamber were separated by a commercially-available hydrocarbon-based anion exchange membrane. The catholyte was an aqueous solution of 16 wt % dissolved KOH. The electrolyte fed to the middle “brine” electrolyte chamber was an aqueous solution of 21 wt % dissolved KCl. The anolyte was an aqueous solution of 21 wt % dissolved KCl. The electrolytic cell was operated at 100 mA/cm² current density with a voltage of 1.45 V, which corresponded to 0.2 g/hr of KOH production per cm² of electrode area at an energy consumption of 0.7 MWh/ton_{KOH}. The experimentally observed production rate and energy efficiency indicated that the embodiments discussed in this disclosure could perform efficient and cost effective capture and release of carbon dioxide using electrolytically generated basic species and acidic species.

### Example 2

This Example describes operation of an electrolytic cell using aqueous input streams described in this disclosure to produce base-rich product streams and acid-rich product streams usable in various of the embodiments for capture and release of carbon dioxide discussed in this disclosure. Specifically, a two-compartment electrolytic cell was employed to treat a sodium dihydrogen phosphate input solution sent to the anolyte chamber.

The electrolytic cell had the configuration shown in FIG. 2B, employing a platinum-coated Ni mesh cathode, a platinum/carbon gas diffusion anode, and two liquid chambers with the catholyte and anolyte chamber separated by a Nafion™ sulfonated tetrafluoroethylene based fluoropolymer-copolymer cation exchange membrane. The catholyte was an aqueous solution of 5 wt % dissolved NaOH. The anolyte was an aqueous solution of 26 wt % dissolved NaH₂PO₄ and 26 wt % dissolved H₃PO₄. The electrolytic cell was operated at 110 mA/cm² current density with a voltage of 1.5 V, which corresponded to 0.23 g/hr of NaOH production per cm² of electrode area at an energy consumption of 0.72 MWh/ton_{NaOH}. The experimentally observed production rate and energy efficiency indicated that the embodiments discussed in this disclosure could perform efficient and cost effective capture and release of carbon dioxide using electrolytically generated basic species and acidic species.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for treating a gas stream comprising carbon dioxide, comprising:
transporting an aqueous input stream to an electrolytic cell, the aqueous input stream comprising dissolved cations and dissolved anions, wherein the cations comprise metal cations and/or ammonium cations and are present at a concentration of greater than or equal to 0.1 M, and wherein the anions comprise halide ions, oxyanions, and/or conjugate bases of organic acids and are present at a concentration of greater than or equal to 0.1 M;
applying an electrical potential difference across the electrolytic cell and performing one or more reactions to produce:
a base-rich product solution comprising electrogenerated basic species and at least some of the cations; and
an acid-rich product solution comprising electrogenerated acidic species and at least some of the anions;
exposing at least some of the electrogenerated basic species to carbon dioxide from an input gas stream to generate:
a carbon dioxide-lean output gas stream having a lower concentration of carbon dioxide than the input gas stream; and
a capture stream comprising:
at least some of the cations, and
dissolved carbonate anions and/or dissolved bicarbonate anions formed from the carbon dioxide; and
exposing at least some of the electrogenerated acidic species to at least some of the dissolved carbonate anions and/or dissolved bicarbonate anions to generate:
a carbon dioxide-rich output gas stream having a higher concentration of carbon dioxide than the input gas stream; and
a release stream comprising at least some of the dissolved cations and at least some of the dissolved anions.

2. A method for treating a gas stream comprising carbon dioxide, comprising:
transporting an aqueous input stream to an electrolytic cell, the aqueous input stream comprising dissolved cations and dissolved anions, wherein the cations comprise metal cations and/or ammonium cations and are present at a concentration of greater than or equal to 0.1 M, and wherein the anions comprise halide ions, oxyanions, and/or conjugate bases of organic acids and are present at a concentration of greater than or equal to 0.1 M;
applying an electrical potential difference across the electrolytic cell and performing one or more reactions involving one or more components of the aqueous input stream to produce:
a base-rich product solution comprising electrogenerated basic species; and
an acid-rich product solution comprising electrogenerated acidic species;
exposing at least some of the electrogenerated basic species to carbon dioxide from an input gas stream to generate:
a carbon dioxide-lean output gas stream having a lower concentration of carbon dioxide than the input gas stream; and
a capture stream comprising dissolved carbonate anions and/or dissolved bicarbonate anions formed from the carbon dioxide;
exposing at least some of the electrogenerated acidic species to at least some of the dissolved carbonate anions and/or dissolved bicarbonate anions to generate:
a carbon dioxide-rich output gas stream having a higher concentration of carbon dioxide than the input gas stream; and
a release stream comprising at least some of the dissolved cations and at least some of the dissolved anions; and
increasing the concentration of the at least some of the dissolved cations and the at least some of the dissolved anions in the release stream, thereby forming a concentrated release stream.

3. A method for treating a gas stream comprising carbon dioxide, comprising:
transporting an aqueous input stream to an electrolytic cell;
applying an electrical potential difference across the electrolytic cell and performing one or more reactions involving one or more components of the aqueous input stream to produce:
a base-rich product solution produced by an oxygen reduction half-reaction, the base-rich product solution comprising electrogenerated basic species; and
an acid-rich product solution produced by a hydrogen oxidation half-reaction, the acid-rich product solution comprising electrogenerated acidic species;
exposing at least some of the electrogenerated basic species to carbon dioxide from an input gas stream to generate:
a carbon dioxide-lean output gas stream having a lower concentration of carbon dioxide than the input gas stream; and
a capture stream comprising dissolved carbonate anions and/or dissolved bicarbonate anions formed from the carbon dioxide; and
exposing at least some of the electrogenerated acidic species to at least some of the dissolved carbonate anions and/or dissolved bicarbonate anions to generate a carbon dioxide-rich output gas stream having a higher concentration of carbon dioxide than the input gas stream.

4. A method for obtaining an alkali metal-containing material, comprising:
transporting an aqueous input stream and a catholyte input stream to a two-compartment electrolytic cell comprising a catholyte chamber and an anolyte chamber separated by a cation-selective membrane, the aqueous input stream comprising alkali metal cations and non-hydroxide anions; and
applying an electrical potential difference across the electrolytic cell and performing one or more reactions to produce:
a base-rich product solution produced in the catholyte chamber, the base-rich product solution comprising electrogenerated basic species and at least some of the alkali metal cations, wherein the catholyte input stream is transported to the catholyte chamber; and
an anolyte product solution produced by a hydrogen oxidation half-reaction in the anolyte chamber, wherein the aqueous input stream is transported to the anolyte chamber;
wherein the catholyte input stream comprises at least a portion of the base-rich product solution.

5. The method of claim 4, further comprising combining at least a portion of the base-rich product solution with a dilution stream, thereby forming a diluted base-rich product solution, wherein the catholyte input stream comprises at least a portion of the diluted base-rich product solution.

6. A method for obtaining an alkali metal-containing material, comprising:
transporting an aqueous input stream to an electrolytic cell, the aqueous input stream comprising alkali metal cations and non-hydroxide anions;
applying an electrical potential difference across the electrolytic cell and performing one or more reactions to produce:
a base-rich product solution comprising electrogenerated basic species and at least some of the alkali metal cations; and
an anolyte product solution produced by a hydrogen oxidation half-reaction and/or an oxygen evolution reaction in an anolyte chamber that receives at least some of the non-hydroxide anions, the hydrogen oxidation half-reaction and/or the oxygen evolution reaction resulting in the protonation of at least some of the non-hydroxide anions; and
combining at least a portion of the anolyte product solution with a stream containing dissolved carbonate anions and/or dissolved bicarbonate anions to generate:
a carbon dioxide-rich output gas stream comprising carbon dioxide; and
a release stream containing at least some of the non-hydroxide anions.

7. The method of claim 6, wherein the anolyte product solution is produced by a hydrogen oxidation half-reaction.

8. The method of claim 6, wherein the anolyte product solution is produced by an oxygen evolution half-reaction.

9. A method for obtaining an alkali metal-containing material, comprising:
transporting an aqueous input stream to an anolyte chamber of a two-compartment electrolytic cell comprising a catholyte chamber and the anolyte chamber separated by a cation-selective membrane, the aqueous input stream comprising alkali metal cations and non-hydroxide anions; and
applying an electrical potential difference across the electrolytic cell and performing one or more reactions to produce:
a base-rich product solution comprising electrogenerated basic species and at least some of the alkali metal cations; and
an anolyte product solution produced by a hydrogen oxidation half-reaction in the anolyte chamber, wherein the aqueous input stream is transported to the anolyte chamber, wherein the anolyte product solution comprises electrogenerated acidic species, wherein a concentration of the acidic species in the anolyte product solution is greater than a concentration of the acidic species in the aqueous input stream;
wherein the aqueous input stream comprises at least a portion of the anolyte product solution.

10. The method of claim 9, wherein the aqueous input stream comprises the acidic species, and wherein a molar ratio of the concentration of the acidic species in the anolyte product solution to the concentration of the acidic species in the aqueous input stream is at least 1.005.

11. The method of claim 9, further comprising combining at least a portion of the anolyte product solution with a dilution stream, thereby forming a diluted anolyte product solution, wherein the aqueous input stream comprises at least a portion of the diluted anolyte product solution.

12. The method of claim 4, wherein the anolyte product solution comprises at least some of the non-hydroxide anions and/or conjugate acids of at least some of the non-hydroxide anions.

13. The method of claim 4, wherein the anolyte product solution comprises at least some of the non-hydroxide anions.

14. The method of claim 4, wherein the anolyte product solution has a lower pH than the aqueous input stream.

15. The method of claim 4, wherein the anolyte product solution is an acid-rich product solution comprising electrogenerated acidic species.

16. The method of claim 4, wherein the alkali metal cations comprise sodium cations and/or potassium cations.

17. The method of claim 4, wherein the method comprises dissolving a solid alkali metal salt comprising the alkali metal cations and non-hydroxide anions to form at least a portion of the aqueous input stream.

18. The method of claim 4, wherein at least a portion of the anolyte product solution is recirculated back to the electrolytic cell.

19. The method of claim 1, wherein the anions comprise halide ions, sulfate ions, nitrate ions, phosphate ions, borate ions, perchlorate anions, and/or conjugate bases of organic acids.

20. The method of claim 1, wherein the anions comprise halide ions, sulfate ions, nitrate ions, phosphate ions, borate ions, and/or conjugate bases of organic acids.

21. The method of claim 1, wherein the dissolved anions comprise conjugate bases of weak acids.

22. The method of claim 1, wherein the anions comprise chloride ions.

23. The method of claim 1, wherein the anions comprise phosphate ions.

24. The method of claim 23, wherein the phosphate ions comprise orthophosphate ions (PO₄³⁻), monohydrogen phosphate ions (HPO₄²⁻), and/or dihydrogen phosphate ions (H₂PO₄⁻).

25. The method of claim 1, wherein the exposing the at least some of the electrogenerated basic species to carbon dioxide comprises contacting at least a portion of the base-rich product solution with the input gas stream in a gas-liquid contact vessel.

26. The method of claim 1, wherein the aqueous input stream comprises at least a portion of the release stream.

27. The method of claim 1, further comprising increasing the concentration of the dissolved cations and the at least some of the dissolved anions in the release stream, thereby forming a concentrated release stream.

28. The method of claim 27, wherein the increasing the concentration comprises removing at least a portion of water from the release stream.

29. The method of claim 27, wherein the aqueous input stream comprises at least a portion of the concentrated release stream.

30. The method of claim 27, further comprising combining at least a portion of the base-rich product solution with a dilution stream, thereby forming a diluted base-rich product solution.

31. The method of claim 30, wherein the dilution stream comprises at least a portion of water removed from the release stream during formation of the concentrated release stream.

32. The method of claim 1, wherein the basic species comprises hydroxide ions.

33. The method of claim 1, wherein the acidic species comprises hydronium ions.

34. The method of claim 1, wherein the acidic species comprises acetic acid.

35. The method of claim 1, wherein the acidic species comprises benzoic acid.

36. The method of claim 1, wherein the acidic species comprises formic acid.

37. The method of claim 1, wherein the acidic species comprises phosphoric acid (H₃PO₄).

38. The method of claim 1, wherein the acidic species comprises dihydrogen phosphate ions (H₂PO₄⁻).

39. The method of claim 1, wherein the acidic species comprises boric acid (H₃BO₃).

40. The method of claim 1, wherein the cations comprise alkali metal cations and/or ammonium cations.

41. The method of claim 1, wherein the cations comprise sodium ions, potassium ions, and/or ammonium cations.

42. The method of claim 1, wherein the input gas stream comprises carbon dioxide in an amount of less than or equal to 100,000 ppm by volume.

43. The method of claim 1, wherein the input gas stream comprises carbon dioxide in an amount of less than or equal to 1,000 ppm by volume.

44. The method of claim 1, wherein the electrolytic cell comprises a catholyte chamber and an anolyte chamber separated by at least one ion-selective membrane.

45. The method of claim 44, wherein the at least one ion-selective membrane comprises a cation-selective membrane, and wherein the aqueous input stream is transported to the anolyte chamber.

46. The method of claim 45, further comprising combining at least a portion of the base-rich product solution with a dilution stream, thereby forming a diluted base-rich product solution wherein the aqueous input stream is a first aqueous input stream and comprises at least a portion of the release stream and at least a portion of the capture stream, and wherein the method further comprises transporting a second aqueous input stream to the catholyte chamber, the second aqueous input stream comprising at least a portion of the diluted base-rich product solution.

47. The method of claim 45, further comprising combining at least a portion of the base-rich product solution with a dilution stream, thereby forming a diluted base-rich product solution wherein the aqueous input stream is a first aqueous input stream and comprises at least a portion of the concentrated release stream, and wherein the method further comprises transporting a second aqueous input stream to the catholyte chamber, the second aqueous input stream comprising at least a portion of the diluted base-rich product solution.

48. The method of claim 44, wherein the at least one ion-selective membrane comprises an anion-selective membrane, and wherein the aqueous input stream is transported to the catholyte chamber.

49. The method of claim 48, wherein the aqueous input stream is a first aqueous input stream and comprises at least a portion of the release stream, and wherein the method further comprises transporting a second aqueous input stream to the anolyte chamber, the second aqueous input stream comprising at least a portion of the capture stream.

50. The method of claim 44, wherein the electrolytic cell further comprises an electrolyte chamber separated from the catholyte chamber by a cation selective membrane and separated from the anolyte chamber by an anion-selective membrane, and wherein the aqueous input stream is transported to the electrolyte chamber.

51. The method of claim 44, wherein the performing the one or more reactions comprises performing the hydrogen oxidation reaction in the anolyte chamber and performing the hydrogen evolution reaction in the catholyte chamber.

52. The method of claim 44, wherein the performing the one or more reactions comprises performing the hydrogen oxidation reaction in the anolyte chamber and performing the oxygen reduction reaction in the catholyte chamber.

53. The method of claim 44, wherein the performing the one or more reactions comprises performing the oxygen evolution reaction in the anolyte chamber and performing the oxygen reduction reaction in the catholyte chamber.

54. The method of claim 1, wherein the electrolytic cell is operated as an electrodialysis cell.

55. The method of claim 1, wherein the electrolytic cell comprises a bipolar membrane.

56. A system for treating a gas stream comprising carbon dioxide, comprising:
an electrolysis assembly comprising:
an electrolytic cell comprising an anode and a cathode;
one or more electrolysis assembly liquid inlets configured to supply dissolved ions to the anode and/or the cathode;
a first electrolysis assembly liquid outlet; and
a second electrolysis assembly liquid outlet; and
a gas-liquid contact vessel comprising:
a contact vessel gas inlet;
a contact vessel liquid inlet fluidically connected to the first electrolysis assembly liquid outlet;
a contact vessel gas outlet; and
a contact vessel liquid outlet;
wherein the one or more electrolysis assembly liquid inlets are fluidically connected to the second electrolysis assembly liquid outlet and the contact vessel liquid outlet.

57. The system of claim 56, further comprising a concentrator comprising a concentrator liquid inlet configured to receive a liquid comprising a solute and a concentrated stream outlet configured to output a liquid comprising the solute at a higher concentration of the solute, wherein the concentrator liquid inlet is fluidically connected to the second electrolysis assembly liquid outlet and contact vessel liquid outlet, and wherein the concentrated stream outlet is fluidically connected to the one or more electrolysis assembly liquid inlets.

58. The system of claim 57, wherein the concentrator is configured to remove water from the liquid received by the concentrator liquid inlet.

59. The system of claim 57, wherein the concentrator comprises a reverse osmosis unit and/or a thermal concentrator.

60. The system of claim 57, wherein the concentrator comprises a diluted stream outlet configured to output at least a portion of water removed from the liquid received by the concentrator inlet, wherein the diluted stream outlet is fluidically connected to the contact vessel liquid inlet.

61. The system of claim 57, wherein the concentrator comprises a diluted stream outlet configured to output at least a portion of water removed from the liquid received by the concentrator inlet, wherein the diluted stream outlet is fluidically connected to the first electrolysis assembly liquid outlet.

62. The system of claim 56, wherein the electrolytic cell comprises a catholyte chamber comprising the cathode and an anolyte chamber comprising the anode, separated by at least one ion-selective membrane.

63. The system of claim 62, wherein the at least one ion-selective membrane comprises a cation-selective membrane, and the one or more electrolysis assembly inlets is configured to supply dissolved ions to the anolyte chamber.

64. The system of claim 63, wherein the anolyte chamber comprises an inlet fluidically connected to the second electrolysis assembly liquid outlet and the contact vessel liquid outlet, and wherein the catholyte chamber comprises an inlet fluidically connected to the first electrolysis assembly liquid outlet.

65. The system of claim 63, further comprising a concentrator comprising a concentrator liquid inlet configured to receive a liquid comprising a solute and a concentrated stream outlet configured to output a liquid comprising the solute at a higher concentration of the solute, wherein the concentrator liquid inlet is fluidically connected to the second electrolysis assembly liquid outlet and contact vessel liquid outlet, and wherein the concentrated stream outlet is fluidically connected to the one or more electrolysis assembly liquid inlets, wherein the anolyte chamber comprises an inlet fluidically connected to the concentrated stream outlet of the concentrator, and wherein the catholyte chamber comprises an inlet fluidically connected to the first electrolysis assembly liquid outlet.

66. The system of claim 62, wherein the at least one ion-selective membrane comprises an anion-selective membrane, and one or more electrolysis assembly inlets is configured to supply dissolved ions to the catholyte chamber.

67. The system of claim 66, wherein the catholyte chamber comprises an inlet fluidically connected to the second electrolysis assembly liquid outlet, and wherein the catholyte chamber comprises an inlet fluidically connected to the contact vessel liquid outlet.

68. The system of claim 62, wherein the electrolytic cell further comprises an electrolyte chamber separated from the catholyte chamber by a cation selective membrane and separated from the anolyte chamber by an anion-selective membrane, and the one or more electrolysis assembly inlets is configured to supply dissolved ions to the electrolyte chamber.

69. The system of claim 56, wherein the cathode is configured to perform the hydrogen evolution reaction.

70. The system of claim 56, wherein the anode is configured to perform the hydrogen oxidation reaction.

71. The system of claim 56, wherein the electrolytic cell is configured to be operated as an electrodialysis cell.

72. The system of claim 56, wherein the electrolytic cell comprises a bipolar membrane.
